(19) United States
(12) Patent Application Publication
(10) Pub. No.: US 2019/0077999 A1
(43) Pub. Date: Mar. 14, 2019

(54) PRESSURE-SENSITIVE ADHESIVE SHEET

(71) Applicant: NITTO DENKO CORPORATION, Ibaraki-shi, Osaka (JP)

(72) Inventors: Hiroki IEDA, Ibaraki-shi (JP); Tatsuya SUZUKI, Ibaraki-shi (JP); Kenji FURUTA, Ibaraki-shi (JP); Minami WATANABE, Ibaraki-shi (JP); Takeshi NAKANO, Ibaraki-shi (JP); Shogo SASAKI, Ibaraki-shi (JP)

(73) Assignee: NITTO DENKO CORPORATION, Ibaraki-shi, Osaka (JP)

(21) Appl. No.: 15/771,636

(22) PCT Filed: Nov. 20, 2017
(86) PCT No.: PCT/JP2017/041674

§ 371 Date: Apr. 27, 2018

(30) Foreign Application Priority Data
Nov. 21, 2016 (JP) 2016-226289

(51) Int. Cl. C09J 7/38; C09J 183/04; C09J 201/02

(52) U.S. Cl. CPC C09J 7/385; B32B 7/12; C09J 201/02; C09J 183/04

(57) ABSTRACT

The present invention provides a pressure-sensitive adhesive (PSA) sheet that achieves both low initial adhesiveness and strong adhesiveness upon use and has excellent transparency of the PSA layer. The PSA sheet provided herein includes a PSA layer having a haze value of 1.0% or less. The PSA sheet is configured so that a pressure-sensitive adhesive strength N1, after the PSA layer is attached to a stainless steel plate and left at 23° C. for 30 minutes, is 1.5 N/20 mm or less, and a pressure-sensitive adhesive strength N2, after the PSA layer is attached to a stainless steel plate and heated at 80° C. for 5 minutes, is 10.0 N/20 mm or more.

### TECHNICAL FIELD

The present invention relates to a pressure-sensitive adhesive sheet.

The present invention claims priority to Japanese Patent Application No. 2016-226289 filed on 21 Nov. 2016, and the entire contents thereof are incorporated herein by reference.

### BACKGROUND ART

Pressure-sensitive adhesive (PSA) sheets are used for adhering adherends together or fixing an article to an adherend by strongly adhering to the adherend. Various properties are required for PSA sheets in accordance with the application and, for example, there is a need for PSA sheets which take reattaching ability (reworkability) into account in order to prevent a reduction of yield due to erroneous adhesion. Namely, there is a need for PSA sheets which exert low pressure-sensitive adhesive strength (hereinafter, pressure-sensitive adhesive strength is simply referred to as “adhesive strength”) at an early stage after attachment and then exert high adhesive strength when an adherend is used. Background art documents relating to PSA sheets having such properties include Patent Documents 1 to 3.

### CITATION LIST

### Patent Document

Patent Document 1: Japanese Patent Application Publication No. 2014-224227

Patent Document 2: Japanese Patent No. 5890596

Patent Document 3: Japanese Patent No. 5951153

### SUMMARY OF INVENTION

### Technical Problem

Meanwhile, some applications of PSA sheets require transparency of the pressure-sensitive adhesive layer. Examples of the PSA sheet required to have such properties include PSA sheets which may be used by being attached to optical components. Thus, an object of the present invention is to provide a PSA sheet that has both low initial adhesiveness and strong adhesiveness upon use and has excellent transparency of the PSA layer.

### Solution to Problem

The PSA sheet provided herein includes a PSA layer having a haze value of 1.0% or less. The PSA sheet is configured so that an adhesive strength N1, after the PSA layer is attached to a stainless steel plate (SUS304BA plate) and left at 23° C. for 30 minutes, is 1.5 N/20 mm or less and an adhesive strength N2, after the PSA layer is attached to a stainless steel plate (SUS304BA plate) and heated at 80° C. for 5 minutes, is 10.0 N/20 mm or more. The PSA sheet having such configurations have both low initial adhesiveness and strong adhesiveness upon use and has excellent transparency of the PSA layer. Therefore, the PSA sheet may be preferably used for various applications including applications that require transparency of PSA layers (such as applications attached to optical components).

In some embodiments, the PSA layer may have a thickness of 5 μm or more but 35 μm or less. The PSA layer having a thickness of 35 μm or less may be advantageous from the viewpoint of reduction of the haze value. When the PSA layer has a thickness of 5 μm or more, a PSA sheet having high adhesive strength N2 after heating at 80° C. for 5 minutes (hereinafter also referred to as “post-heating adhesive strength”) may be easily obtained.

In some embodiments, the PSA layer may contain a monomer unit derived from a (meth)acrylic monomer at a proportion of above 50% by weight in total monomer units in the PSA layer. As used herein, the phrase “total monomer units in the PSA layer” refers to whole monomer units corresponding to the composition of all polymers included in the PSA layer. The PSA layer using the (meth)acrylic monomer at above proportion may easily have low haze value. By using the (meth)acrylic monomer at such a proportion, a PSA sheet having low adhesive strength N1 after leaving at 23° C. for 30 minutes (hereinafter also referred to as “initial adhesive strength”) and high post-heating adhesive strength may be suitably obtained.

In some embodiments, the PSA layer may contain a monomer unit derived from a monomer having a polyorganosiloxane skeleton at a proportion of 0.05% by weight or more but 5% by weight or less in total monomer units in the PSA layer. By using the monomer having a polyorganosiloxane skeleton at the above proportion, a PSA sheet having low haze value of the PSA layer and fulfilling above adhesive strengths N1 and N2 may be suitably obtained.

In some embodiments, the PSA layer may contain an acrylic polymer Pa having a glass transition temperature of 0° C. or lower and a siloxane structure-containing polymer Ps. By using the polymer Pa and the polymer Ps in combination, a PSA sheet achieving both low initial adhesiveness and strong adhesiveness upon use may be suitably obtained.

The content of the siloxane structure-containing polymer Ps may be, for example, 0.1 parts by weight or more but less than 10 parts by weight relative to 100 parts by weight of the acrylic polymer Pa. According to the composition, a PSA sheet having low haze value of the PSA layer and fulfilling above adhesive strengths N1 and N2 may be easily obtained.

In some embodiments, the siloxane structure-containing polymer Ps which may be preferably used has a weight average molecular weight (Mw) of 1×10⁴ or more but less than 5×10⁴. According to the siloxane structure-containing polymer Ps having Mw within the above range, a PSA sheet fulfilling above adhesive strength N1 and adhesive strength N2 may be easily obtained.

The PSA sheet disclosed herein may be exploited in the form including a support substrate, wherein the PSA layer is laminated at least on one side of the support substrate, namely in the form of the PSA sheet with a substrate. Such a PSA sheet with a substrate may have preferable handling and processing properties. Because of the configuration including the PSA layer having excellent transparency on a support substrate, the PSA sheet may be preferably used in an embodiment in which, for example, an appearance of the support substrate is utilised to exhibit display or decoration functions through the PSA layer.

In some embodiments, the support substrate may be a transparent resin film. The PSA sheet with a substrate having such configuration may be preferably used for applications in which the PSA sheet is required to have light transmittance (optical transparency) or transparency.

In some embodiments, the PSA sheet has the adhesive strength N2 that is 20 times or more of the adhesive strength N1. The PSA sheet having the ratio of the adhesive strength N2 to the adhesive strength N1 (namely, N2/N1; hereinafter also referred to as “adhesive strength rise ratio”) of 20 or more may achieve both low initial adhesiveness and strong adhesiveness upon use at high levels.

### BRIEF DESCRIPTION OF DRAWINGS

The combinations of the elements described hereinabove may be encompassed by the scope of the invention for which the protection by patent is sought by the present application.

FIG. 1 is a schematic section view of the configuration of the PSA sheet according to one embodiment.

FIG. 2 is a schematic section view of the configuration of the PSA sheet according to another embodiment.

FIG. 3 is a schematic section view of the configuration of the PSA sheet according to another embodiment.

### DESCRIPTION OF EMBODIMENTS

Preferable embodiments of the present invention are described below. Matters necessary to practice this invention other than those specifically referred to in this description can be understood by a person skilled in the art based on the disclosure about implementing the invention in this description and common technical knowledge at the time the application was filed. The present invention can be practiced based on the contents disclosed in this description and common technical knowledge in the subject field.

In the following drawings, components or units having the same functions may be described with the same symbols allocated and the redundant description may be omitted or simplified. The embodiments illustrated in the drawings are schematic in order to clearly describe the present invention and the drawings do not accurately represent the size or scale of products actually provided.

As used herein, the term “acrylic polymer” refers to a polymer having a monomer unit derived from a (meth)acrylic monomer in the polymer structure and typically refers to a polymer containing over 50% by weight monomer units derived from a (meth)acrylic monomer. The term “(meth)acrylic monomer” refers to a monomer having at least one (meth)acryloyl group in one molecule. In this context, it is intended that the term “(meth)acryloyl group” collectively refers to an acryloyl group and a methacryloyl group. Therefore, the concept of “(meth)acrylic monomer” as used herein may encompass both a monomer (acrylic monomer) having an acryloyl group and a monomer (methacrylic monomer) having a methacryloyl group. Similarly, it is intended that the term “(meth)acrylic acid” as used herein collectively refers to acrylic acid and methacrylic acid and the term “(meth)acrylate” collectively refers to an acrylate and a methacrylate.

<Structural Examples of the PSA Sheet>

The PSA sheet disclosed herein includes a PSA layer. The PSA sheet disclosed herein may have a form of PSA sheet with a substrate in which the PSA layer is laminated on one or either side of a support substrate or a form of substrate-free PSA sheet without a support substrate. Hereinafter, the support substrate may sometimes be simply referred to as “substrate”.

FIG. 1 schematically represents the structure of a PSA sheet according to an embodiment. The PSA sheet 1 is configured as a one-sided PSA sheet with a substrate, including a sheet shaped support substrate (such as a resin film) 10 having a first surface 10A and a second surface 10B, and a PSA layer 21 provided on the side of the first surface 10A. The PSA layer 21 is provided securely on the side of the first surface 10A of the support substrate 10, namely provided without intending to separate the PSA layer 21 from the support substrate 10. The PSA sheet 1 is used by attaching the PSA layer 21 to an adherend. The PSA sheet 1 before use (namely before attachment to an adherend) may be, as shown in FIG. 1, a constituent of a release-lined PSA sheet 100 in which the surface (pressure-sensitive adhesive surface) 21A of the PSA layer 21 is protected by a release liner 31 having a release surface at least on the side facing to the PSA layer 21. The release liner 31 which may be preferably used is, for example, one having a release layer provided by treatment with a release treatment agent on one side of a sheet shaped substrate (liner substrate) so that the side serves as a release surface. Alternatively, the release liner 31 may be omitted, a support substrate 10 having a second surface 10B that serves as a release surface may be used and a PSA sheet 1 may be wound (to be in a rolled form), thereby protecting the PSA surface 21A while being in contact with the second surface 10B of the support substrate 10.

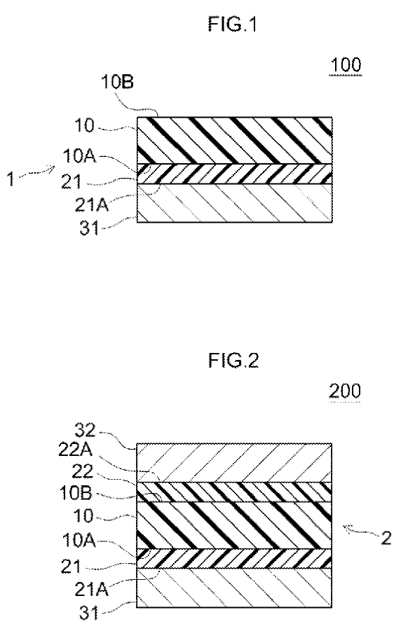

FIG. 2 schematically represents the structure of a PSA sheet according to another embodiment. The PSA sheet 2 is configured as a double-sided PSA sheet (PSA sheet that is adhesive on both sides) with a substrate, including a sheet-shaped support substrate (such as a resin film) 10 having a first surface 10A and a second surface 10B, a PSA layer 21 securely provided on the side of the first surface 10A and a PSA layer 22 securely provided on the side of the second surface 10B. The PSA sheet 2 is used by attaching the PSA layer (first PSA layer) 21 and the PSA layer (second PSA layer) 22 at different sites of an adherend. The PSA layers 21 and 22 may be attached to sites of different components or different sites in a single component. The PSA sheet 2 before use may be, as shown in FIG. 2, a constituent of a release-lined PSA sheet 200 in which a surface (first PSA surface) 21A of the PSA layer 21 and a surface (second PSA surface) 22A of the PSA layer 22 are protected by release liners 31 and 32, respectively, having release surfaces at least on the sides facing to the PSA layers 21 and 22, respectively. The release liners 31 and 32 which may be preferably used are, for example, those respectively having a release layer provided by treatment with a release treatment agent on one side of a sheet-shaped substrate (liner substrate) so that the side serves as a release surface. Alternatively, the release liner 32 may be omitted, the release liner 31 having either side that serve as release surfaces may be used, which may be stacked with the PSA sheet 2 and spirally wound (to be in a rolled form), thereby forming a release-lined PSA sheet in which the second PSA surface 22A is protected while being in contact with the back surface of the release liner 31.

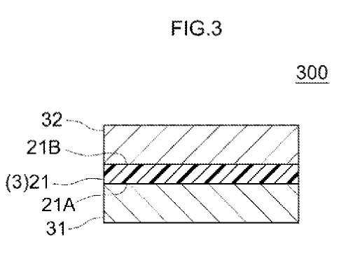

FIG. 3 schematically represents the structure of a PSA sheet according to another embodiment. The PSA sheet 3 is configured as a substrate-free double-sided PSA sheet formed with a PSA layer 21. The PSA sheet 3 is used by attaching a first PSA surface 21A formed with one surface (first surface) of the PSA layer 21 and a second PSA surface 21B formed with another surface (second surface) of the PSA layer 21 at different sites of an adherend. The PSA sheet 3 before use may be, as shown in FIG. 3, a constituent of a release-lined PSA sheet 300 in which the first PSA surface 21A and the second PSA surface 21B are protected by release liners 31 and 32, respectively, having release surfaces at least on the sides facing to the PSA layer 21. Alternatively, the release liner 32 may be omitted, the release liner 31 having either side that serves as release surfaces may be used, which may be stacked with the PSA sheet 3 and spirally wound (to be in a rolled form), thereby forming a release-lined PSA sheet in which the second PSA surface 21B is protected while being in contact with the back surface of the release liner 31.

The concept of the PSA sheet described herein may encompass those referred to as a PSA tape, a PSA film, a PSA label and the like. The PSA sheet may be in a rolled form or in a sheet form or may be one cut or punched into an appropriate shape in accordance with the application or the mode of usage. Typically, the PSA layer in the technique disclosed herein is continuously formed. However, the present invention is not limited thereto and the PSA layer may be formed into a regular or random pattern such as dot-like or stripe pattern.

<PSA Layer>

In the technique disclosed herein, the PSA included in the PSA layer is not particularly limited and may be a PSA containing, as a base polymer (namely a component that accounts for 50% by weight or more of polymer components), one or two or more polymers exhibiting rubber elasticity in room temperature region such as an acrylic polymer, a rubber polymer, a polyester polymer, a urethane polymer, a polyether polymer, a silicone polymer, a polyamide polymer and a fluorine-containing polymer and the like that are known in the field of PSAs. The PSA layer according to the technique disclosed herein may be formed from a PSA composition containing such a base polymer. The form of the PSA composition is not particularly limited and may be any of, for instance, water-dispersed, solvent-based, hot melt, active energy ray curable (such as photocurable) PSA compositions.

(Base Polymer)

The base polymer preferably has a glass transition temperature (Tg) of lower than 0° C. and more preferably lower than −10° C. (such as lower than −20° C.). The PSA containing the base polymer having such Tg exhibits appropriate fluidity (such as mobility of polymer chains in the PSA), and thus is suitable for obtaining the PSA sheet having low initial adhesive strength and high post-heating adhesive strength. In some embodiments, base polymer may have Tg of lower than −30° C. or lower than −40° C. The lower limit of Tg of the base polymer is not particularly restricted. From the viewpoint of availability of materials and improvement of cohesive strength of the PSA layer, a base polymer having Tg of −80° C. or higher may be generally and suitably employed. In some embodiments, the base polymer may have Tg of, for example, −63° C. or higher, −55° C. or higher, −50° C. or higher or −45° C. or higher.

Tg of the base polymer as used herein refers to a nominal value indicated in references or catalogues or Tg determined from the Fox equation on the basis of the composition of monomer components used for preparation of the base polymer. The Fox equation is, as indicated below, the relational expression between Tg of a copolymer and glass transition temperature Tgi of homopolymers obtained by homopolymerisation of respective monomers included in the copolymer.

1/Tg=Σ(Wi/Tgi)

In the above Fox equation, Tg represents the glass transition temperature (unit: K) of a copolymer, Wi is the weight fraction (copolymerisation ratio based on weight) of monomer i in the copolymer, and Tgi represents the glass transition temperature (unit: K) of a homopolymer of monomer i. When the base polymer is a homopolymer, the homopolymer and the base polymer has the same Tg.

The glass transition temperature of a homopolymer used for calculation of Tg is the value indicated in a known document. Specifically, the value is included in “Polymer Handbook” (third edition, John Wiley & Sons, Inc., 1989). For a monomer more than one values are given in Polymer Handbook, the highest value is employed. The glass transition temperature of a homopolymer of a monomer the value for which is not indicated in Polymer Handbook is the value obtained by the measurement method disclosed in Japanese Patent Application Publication No. 2007-51271.

Specifically, in a reactor equipped with a thermometer, a stirrer, a nitrogen inlet tube and a reflux condenser, 100 parts by weight of monomer, 0.2 parts by weight of 2,2′-azobisisobutyronitrile and, as a polymerisation solvent, 200 parts by weight of ethyl acetate are charged and stirred for 1 hour while circulating nitrogen gas. After removing oxygen in the polymerization system as above, the reactor is heated to 63° C. and the reaction is allowed to proceed for 10 hours. The reaction system is then cooled to room temperature to obtain a homopolymer solution having a solid content of 33% by weight. The homopolymer solution is then applied onto a release liner by casting and dried to prepare a test sample (a homopolymer sheet) of a thickness of about 2 mm. The test sample is punched out into a disc with a diameter of 7.9 mm, sandwiched between parallel plates, measured for viscoelasticity on a viscoelasticity analyser (produced by TA Instruments Japan, model name: “ARES”) in a shear mode while applying shear strain at a frequency of 1 Hz in a temperature range from −70° C. to 150° C. at a heating rate of 5° C./minute, thereby obtaining the temperature corresponding to the peak top temperature of tan8 which is regarded as Tg of the homopolymer.

Without particular limitation, the base polymer typically has a weight average molecular weight (Mw) of approximately 5×10⁴ or more. With the base polymer having such Mw, the PSA exhibiting preferable cohesiveness may be easily obtained. In some embodiments, the base polymer may have Mw of, for example, 10×10⁴ or more, 20×10⁴ or more or 30×10⁴ or more. It is generally appropriate that the base polymer has Mw of approximately 500×10⁴ or less. The base polymer having such Mw may easily form the PSA exhibiting appropriate fluidity (mobility of polymer chains), and thus is suitable for obtaining the PSA sheet having low initial adhesive strength and high post-heating adhesive strength.

In the present specification, Mw of the base polymer or the siloxane structure-containing polymer described hereinafter may be determined by gel permeation chromatography (GPC) based on polystyrene. More specifically, Mw may be measured according to the method and conditions described in Examples hereinbelow.

(Acrylic Polymer Pa)

The PSA sheet disclosed herein may be suitably exploited in a form including the PSA layer formed with the PSA containing, as a base polymer, an acrylic polymer Pa having Tg of 0° C. or lower. Particularly, when the siloxane structure-containing polymer Ps described hereinbelow is a homopolymer or a copolymer containing a monomer unit derived from a (meth)acrylic monomer, an acrylic polymer Pa may be preferably employed as the base polymer because of preferable compatibility with the siloxane structure-containing polymer Ps. Good compatibility of the base polymer with the siloxane structure-containing polymer Ps is advantageous from the viewpoint of an improvement of transparency of the PSA layer. In addition, an improvement of migration property of the siloxane structure-containing polymer Ps in the PSA layer may contribute to a reduction of initial adhesive strength and an improvement of post-heating adhesive strength.

The acrylic polymer Pa may be, for example, a polymer containing 50% by weight or more monomer unit derived from a (meth)acrylic acid alkyl ester, namely a polymer in which 50% by weight or more of the total amount of monomer components for preparation of the acrylic polymer Pa is a (meth)acrylic acid alkyl ester. The (meth)acrylic acid alkyl ester which may be preferably used is a (meth)acrylic acid alkyl ester having a linear or branched alkyl group having 1 to 20 carbon atoms (namely C₁₋₂₀ alkyl ester). The proportion of the (meth)acrylic acid C₁₋₂₀ alkyl ester in the total amount of monomer components may be, for example, 50% by weight to 99.9% by weight, preferably 60% by weight to 98% by weight and more preferably 70% by weight to 95% by weight.

Non-limiting specific examples of the (meth)acrylic acid C₁₋₂₀ alkyl ester include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, isooctadecyl (meth)acrylate, nonadecyl (meth)acrylate, eicosyl (meth)acrylate and the like.

Among others, a (meth)acrylic acid C₁₋₁₈ alkyl ester is preferred and a (meth)acrylic acid C₁₋₁₄ alkyl ester is more preferred. In some embodiments, the acrylic polymer Pa may contain, as a monomer unit, at least one of (meth)acrylic acid C₄₋₁₂ alkyl esters (preferably acrylic acid C₄₋₁₀ alkyl esters such as an acrylic acid C₆₋₁₀ alkyl esters). For example, the acrylic polymer preferably contains one or both of n-butyl acrylate (BA) and 2-ethylhexyl acrylate (2EHA), and the acrylic polymer Pa particularly preferably contains at least 2EHA. Examples of other (meth)acrylic acid C₁₋₁₈ alkyl esters that are preferably used as the monomer component include methyl acrylate, methyl methacrylate (MMA), n-butyl methacrylate (BMA), 2-ethylhexyl methacrylate (2EHMA) and the like.

In some embodiments, more than 50% by weight of (meth)acrylic acid C₁₋₂₀ alkyl esters in monomer components for preparation of the acrylic polymer Pa may be acrylic acid C₆₋₂₀ alkyl esters (such as acrylic acid C₆₋₁₀ alkyl esters). According to such a composition, a PSA sheet having low initial adhesive strength and high post-heating adhesive strength may be easily obtained. In addition, a PSA sheet having high adhesive strength rise ratio may be easily obtained. Suitable examples of the acrylic acid C₆₋₂₀ alkyl ester include 2EHA, isooctyl acrylate, nonyl acrylate, isononyl acrylate and the like. Among others, 2EHA is preferred. The proportion of acrylic acid C₆₋₂₀ alkyl esters among (meth)acrylic acid C₁₋₂₀ alkyl esters may be 60% by weight or more, 70% by weight or more or 80% by weight or more. The technique disclosed herein may be suitably exploited in an embodiment in which substantially all (meth)acrylic acid C₁₋₂₀ alkyl esters in monomer components are acrylic acid C₆₋₂₀ alkyl esters. From the viewpoint of an improvement of cohesive strength of the PSA and an improvement of transparency, the proportion of acrylic acid C₆₋₂₀ alkyl esters among (meth)acrylic acid C₁₋₂₀ alkyl esters in some embodiments may be, for example, 99% by weight or less, 98% by weight or less, 95% by weight or less or 90% by weight or less.

In some other embodiments, more than 50% by weight of (meth)acrylic acid C₁₋₂₀ alkyl esters in monomer components for preparation of the acrylic polymer Pa may be acrylic acid C₂₋₅ alkyl esters. According to such a composition, a PSA layer having low haze value may be easily obtained. Suitable examples of the acrylic acid C₂₋₅ alkyl ester include ethyl acrylate, BA, isobutyl acrylate and the like. Among others, BA is preferred. The proportion of acrylic acid C₂₋₅ alkyl esters among (meth)acrylic acid C₁₋₂₀ alkyl esters may be 70% by weight or more, 80% by weight or more, 90% by weight or more or 95% by weight or more. The technique disclosed herein may be suitably exploited in an embodiment in which substantially all (meth)acrylic acid C₁₋₂₀ alkyl esters in monomer components are acrylic acid C₂₋₅ alkyl esters.

In addition to the (meth)acrylic acid alkyl ester which is the main component, the monomer units that form the acrylic polymer may include, as needed, another monomer (copolymerisable monomer) which is able to copolymerise with the (meth)acrylic acid alkyl ester. As the copolymerisable monomer, a monomer having a polar group (such as a carboxy group, a hydroxy group and a nitrogen atom-containing ring) may be suitably used. The monomer having a polar group may be useful for introducing a cross-linking point into the acrylic polymer or increasing cohesive strength of the acrylic polymer. The copolymerisable monomer used may be one or two or more in combination.

Non-limiting specific examples of the copolymerisable monomer include those indicated below.

Carboxyl group-containing monomers: for example, acrylic acid, methacrylic acid, carboxyethyl acrylate, carboxypentyl acrylate, itaconic acid, maleic acid, fumaric acid, crotonic acid and isocrotonic acid;

Acid anhydride group-containing monomers: for example, maleic anhydride and itaconic anhydride;

Hydroxy group-containing monomers: for example, hydroxyalkyl (meth)acrylates such as 2-hydroxyethyl (meth)acrylate, 2-hydroxypropyl (meth)acrylate, 2-hydroxybutyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)methyl (meth)acrylate;

Monomers having a sulphonate group or a phosphate group: for example, styrene sulphonic acid, allyl sulphonic acid, sodium vinylsulphonate, 2-(meth)acrylamide-2-methylpropane sulphonic acid, (meth)acrylamide propane sulphonic acid, sulphopropyl (meth)acrylate, (meth)acryloyloxy naphthalenesulphonic acid and 2-hydroxyethylacryloyl phosphate;

Epoxy group-containing monomers: for example, epoxy group-containing acrylates such as glycidyl (meth)acrylate and (meth)acrylate-2-ethyl glycidyl ether, allyl glycidyl ether and (meth)acrylate glycidyl ether;

Cyano group-containing monomers: for example, acrylonitrile and methacrylonitrile;

Isocyanato group-containing monomers: for example, 2-isocyanatoethyl (meth)acrylate;

Amido group-containing monomers: for example, (meth)acrylamide; N,N-dialkyl (meth)acrylamides such as N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide and N,N-di(t-butyl) (meth)acrylamide; N-alkyl (meth)acrylamides such as N-ethyl(meth)acrylamide, N-isopropyl(meth)acrylamide, N-butyl(meth)acrylamide and N-n-butyl(meth)acrylamide; N-vinylcarboxylic acid amides such as N-vinylacetamide; and N,N-dimethylaminopropyl(meth)acrylamide, hydroxyethyl acrylamide, N-methylol(meth)acrylamide, N-ethylol(meth)acrylamide, N-methylolpropane(meth)acrylamide, N-methoxymethyl(meth)acrylamide, N-methoxyethyl(meth)acrylamide, N-butoxymethyl(meth)acrylamide and N-(meth)acryloylmorpholine;

Monomers having a nitrogen atom-containing ring: for example, N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinylmorpholine, N-vinyl-3-morpholinone, N-vinyl-2-caprolactam, N-vinyl-1,3-oxazin-2-one, N-vinyl-3,5-morpholinedione, N-vinylpyrazole, N-vinylisoxazole, N-vinylthiazole, N-vinylisothiazole and N-vinylpyridazine (such as lactams including N-vinyl-2-caprolactam);

Monomers having a succinimide skeleton: for example, N-(meth)acryloyloxy methylene succinimide, N-(meth)acryloyl-6-oxy hexamethylene succinimide and N-(meth)acryloyl-8-oxy hexamethylene succinimide;

Maleimides: for example, N-cyclohexylmaleimide, N-isopropylmaleimide, N-laurylmaleimide and N-phenylmaleimide;

Itaconimides: for example, N-methyl itaconimide, N-ethyl itaconimide, N-butyl itaconimide, N-octyl itaconimide, N-2-ethylhexyl itaconimide, N-cyclohexyl itaconimide and N-lauryl itaconimide;

Aminoalkyl (meth)acrylates: for example, aminoethyl (meth)acrylate, N,N-dimethylaminoethyl (meth)acrylate, N,N-diethylaminoethyl (meth)acrylate and t-butylaminoethyl (meth)acrylate;

Alkoxyalkyl (meth)acrylates: for example, methoxyethyl (meth)acrylate, ethoxyethyl (meth)acrylate, propoxyethyl (meth)acrylate, butoxyethyl (meth)acrylate and ethoxypropyl (meth)acrylate;

Vinyl esters: for example, vinyl acetate and vinyl propionate;

Vinyl ethers: for example, vinyl alkyl ethers such as methyl vinyl ether and ethyl vinyl ether;

Aromatic vinyl compounds: for example, styrene, a-methylstyrene and vinyl toluene;

Olefins: for example, ethylene, butadiene, isoprene and isobutylene;

(Meth)acrylic esters having an alicyclic hydrocarbon group: for example, cyclopentyl (meth)acrylate, cyclohexyl (meth)acrylate, isobornyl (meth)acrylate and dicyclopentanyl (meth)acrylate;

(Meth)acrylic esters having an aromatic hydrocarbon group: for example, phenyl (meth)acrylate, phenoxyethyl (meth)acrylate and benzyl (meth)acrylate;

Heterocyclic ring-containing (meth)acrylates such as tetrahydrofurfuryl (meth)acrylate, halogen atom-containing (meth)acrylates such as vinyl chloride and fluorine atom-containing (meth)acrylates, silicon atom-containing (meth)acrylates such as silicone (meth)acrylate, (meth)acrylic esters obtained from terpene compound derivative alcohols and the like.

When using such a copolymerisable monomer, the amount thereof is not particularly limited, and it is generally appropriate that the amount is 0.01% by weight or more of the total amount of monomer components. From the viewpoint of more preferably exerting the effect due to use of the copolymerisable monomer more effectively, the amount of the copolymerisable monomer used may be 0.1% by weight or more or 1% by weight or more of the total amount of monomer components. The amount of the copolymerisable monomer used may be 50% by weight or less or preferably 40% by weight or less of the total amount of monomer components. This may prevent the cohesive strength of the PSA being excessively high and tackiness at normal temperature (25° C.) may be improved.

In some embodiments, the acrylic polymer Pa preferably contains, as a monomer unit, at least one monomer selected from the group consisting of the hydroxy group-containing monomer described above (typically a (meth)acrylic monomer having a hydroxy group) and an N-vinyl cyclic amide represented by the following general formula (M1):

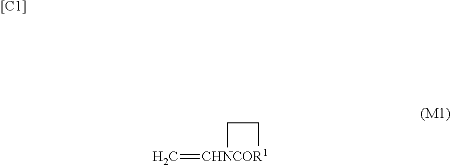

wherein R¹ in the general formula (M1) is a bivalent organic group.

Specific examples of the N-vinyl cyclic amide include N-vinyl-2-pyrrolidone, N-vinyl-2-piperidone, N-vinyl-3-morpholinone, N-vinyl-2-caprolactam, N-vinyl-1,3-oxazin-2-one, N-vinyl-3,5-morpholinedione and the like. N-vinyl-2-pyrrolidone and N-vinyl-2-caprolactam are particularly preferred.

By using the N-vinyl cyclic amide, cohesive strength and polarity of the PSA may be adjusted and post-heating adhesive strength may be improved. In addition, by utilizing the N-vinyl cyclic amide for improvement of cohesive strength, the amount of the crosslinking agent (such as an isocyanate crosslinking agent) described hereinafter may be reduced, which may be advantageous from the viewpoint of improvement of the adhesive strength rise ratio. The N-vinyl cyclic amide may also increase hydrophilicity of the PSA layer, thereby being useful for preventing a reduction of transparency due to moisture.

The amount of the N-vinyl cyclic amide used is not particularly limited and it is generally appropriate that the amount is 0.01% by weight or more (preferably 0.1% by weight or more, such as 0.5% by weight or more) of the total amount of monomer components for preparation of the acrylic polymer Pa. In some embodiments, the amount of the N-vinyl cyclic amide used may be 1% by weight or more, 5% by weight or more or 10% by weight or more of the total amount of monomer components. From the viewpoint of improvement of tackiness at normal temperature (25° C.) and improvement of flexibility at low temperatures, it is generally appropriate that the amount of the N-vinyl cyclic amide used is 40% by weight or less and the amount may be 30% by weight or less or 20% by weight or less of the total amount of monomer components.

Examples of the hydroxy group-containing monomer which may be suitably used include 2-hydroxyethyl (meth)acrylate, 4-hydroxybutyl (meth)acrylate, 6-hydroxyhexyl (meth)acrylate and the like. Among others, preferable examples include 2-hydroxyethyl acrylate (HEA) and 4-hydroxybutyl acrylate (4HBA).

By using the hydroxy group-containing monomer, cohesive strength and polarity of the PSA may be adjusted and post-heating adhesive strength may be improved. In addition, the hydroxy group-containing monomer provides a reaction point for the crosslinking agent (such as an isocyanate crosslinking agent) described hereinbelow and may improve cohesive strength of the PSA by crosslinking reaction. The hydroxy group-containing monomer may also increase hydrophilicity of the PSA layer, thereby being useful for preventing a reduction of transparency due to moisture.

The amount of the hydroxy group-containing monomer used is not particularly limited, and it is generally appropriate that the amount is 0.01% by weight or more (preferably 0.1% by weight or more such as 0.5% by weight or more) of the total amount of monomer components for preparation of the acrylic polymer Pa. In some embodiments, the amount of the hydroxy group-containing monomer used may be 1% by weight or more, 5% by weight or more or 10% by weight or more of the total amount of monomer components. From the viewpoint of improvement of tackiness at normal temperature (25° C.) and improvement of flexibility at low temperatures, it is generally appropriate that the amount of the hydroxy group-containing monomer used is 40% by weight or less and the amount may be 30% by weight or less or 20% by weight or less of the total amount of monomer components.

In some embodiments, the copolymerisable monomer may be a combination of the N-vinyl cyclic amide and the hydroxy group-containing monomer. In this case, the total amount of the N-vinyl cyclic amide and the hydroxy group-containing monomer may be, for example, 0.1% by weight or more, 1% by weight or more, 5% by weight or more, 10% by weight or more, 15% by weight or more, 20% by weight or more or 25% by weight or more of the total amount of monomer components for preparation of the acrylic polymer Pa. The total amount of the N-vinyl cyclic amide and the hydroxy group-containing monomer may be, for example, 50% by weight or less and is preferably 40% by weight or less of the total amount of monomer components.

The monomer components for preparation of the acrylic polymer Pa may contain, as needed, a polyfunctional monomer in order to adjust cohesive strength of the PSA layer or the like. Examples of the polyfunctional monomer include ethylene glycol di(meth)acrylate, propylene glycol di(meth)acrylate, polyethylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, ethylene glycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate, butyldiol (meth)acrylate, hexyldiol di(meth)acrylate and the like. Among others, trimethylolpropane tri(meth)acrylate, 1,6-hexanediol di(meth)acrylate and dipentaerythritol hexa(meth)acrylate may be suitably used. The polyfunctional monomer used may be one or two or more in combination. The amount of the polyfunctional monomer used may vary according to the molecular weight and the number of functional groups. However, it is generally appropriate that the amount is in the range of 0.01% by weight to 3.0% by weight relative to the total amount of monomer components for preparation of the acrylic polymer Pa, and the amount may be 0.02% by weight to 2.0% by weight or 0.03% by weight to 1.0% by weight.

The method for obtaining the acrylic polymer is not particularly limited. Various polymerisation methods known as synthesis methods of acrylic polymers may be appropriately employed such as solution polymerisation, emulsion polymerisation, bulk polymerisation, suspension polymerisation and photopolymerisation. In some embodiments, solution polymerisation may be preferably employed. The polymerisation temperature during solution polymerisation may be appropriately selected according to the monomers and solvents used, the polymerisation initiator and the like, and may be, for example, around 20° C. to 170° C. (typically around 40° C. to 140° C.).

The initiator used for polymerisation may be appropriately selected according to the polymerisation method from conventionally known thermal polymerisation initiators, photopolymerisation initiators and the like. The polymerisation initiator used may be one or two or more in combination.

Examples of the thermal polymerisation initiator include azo polymerisation initiators (such as 2,2′-azobisisobutyronitrile, 2,2′ -azobis-2-methylbutyronitrile, dimethyl 2,2′ -azobis(2-methylpropionate), 4,4′ -azobis-4-cyanovalerianic acid, azobis isovaleronitrile, 2,2′ -azobis(2-amidinopropane) dihydrochloride, 2,2′-azobis[2-(5-methyl-2-imidazolin-2-yl)propane] dihydrochloride, 2,2′-azobis(2-methylpropionamidine) disulphate and 2,2′-azobis(N,N′-dimethyleneisobutylamidine) dihydrochloride); persulphates such as potassium persulphate; peroxide polymerisation initiators (such as dibenzoyl peroxide, t-butyl permaleate and lauroyl peroxide); redox polymerisation initiators and the like. The amount of the thermal polymerisation initiator used is not particularly limited, and may be, for example, in the range of 0.01 parts by weight to 5 parts by weight and preferably 0.05 parts by weight to 3 parts by weight relative to 100 parts by weight of monomer components for preparation of the acrylic polymer.

The photopolymerisation initiator is not particularly limited and examples thereof that may be used include benzoin ether photopolymerisation initiators, acetophenone photopolymerisation initiators, α-ketol photopolymerisation initiators, aromatic sulphonyl chloride photopolymerisation initiators, photoactive oxime photopolymerisation initiators, benzoin photopolymerisation initiators, benzyl photopolymerisation initiators, benzophenone photopolymerisation initiators, ketal photopolymerisation initiators, thioxanthone photopolymerisation initiators, acylphosphine oxide photopolymerisation initiators and the like. The amount of the photopolymerisation initiator used is not particularly limited, and may be, for example, in the range of 0.01 parts by weight to 5 parts by weight and preferably 0.05 parts by weight to 3 parts by weight relative to 100 parts by weight of monomer components for preparation of the acrylic polymer.

In some embodiments, the acrylic polymer Pa may be in the form of a partial polymerisation product (acrylic polymer syrup) obtained by irradiating a mixture containing the above monomer components and the polymerisation initiator with ultraviolet (UV) rays and included in a PSA composition for forming a PSA layer. The PSA composition containing the acrylic polymer syrup may be applied to a predetermined article to be coated and irradiated with ultraviolet rays to complete polymerisation. Namely, the acrylic polymer syrup may be understood to be a precursor or prepolymer of the acrylic polymer Pa. The PSA layer disclosed herein may be formed with, for example, a PSA composition containing the acrylic polymer syrup and the siloxane structure-containing polymer Ps described hereinbelow.

(Siloxane Structure-Containing Polymer Ps)

The PSA layer in the technique disclosed herein may contain, as needed, a component other than the base polymer (such as the acrylic polymer Pa). One suitable example of the arbitrary component may be a siloxane structure-containing polymer Ps. The siloxane structure-containing polymer Ps is defined as a polymer having a siloxane structure (Si—O—Si structure) in the molecule. The siloxane structure-containing polymer Ps may serve as an adhesive strength rise retarder that contributes to a reduction of initial adhesive strength and an improvement of the adhesive strength rise ratio by low polarity and mobility of the siloxane structure. The siloxane structure-containing polymer Ps (hereinafter sometimes abbreviated as “polymer Ps”) which may be preferably used is a polymer having a siloxane structure in a side chain.

The polymer Ps preferably contains, as a monomer unit, a monomer having a polyorganosiloxane skeleton (hereinafter also referred to as “monomer S1”). The monomer S1 which may be used is not particularly limited and may be any monomer having a polyorganosiloxane skeleton. The polyorganosiloxane skeleton-containing monomer has low polarity due to the structure, and thus promotes an uneven distribution of the polymer Ps towards the surface of the PSA layer in the PSA sheet before use (before attachment to an adherend) and exhibits light peelability at an early stage after attachment.

Examples of the monomer S1 which may be used include a compound represented by the following general formula (1) or (2). More specific examples include silicone oils having one terminal reactivity such as X-22-174ASX, X-22-2426, X-22-2475 and KF-2012 produced by Shin-Etsu Chemical Co., Ltd. The monomer S1 used may be one or two or more in combination.

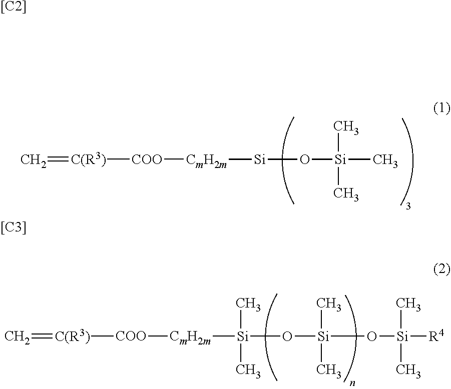

In the above general formulae (1) and (2), R³ is hydrogen or methyl; R⁴ is a methyl group or a monovalent organic group; and m and n are integers of 0 or more.

The monomer S1 preferably has a functional group equivalent of, for example, 700 g/mol or more but less than 15,000 g/mol, more preferably 800 g/mol or more but less than 10,000 g/mol, still more preferably 850 g/mol or more but less than 6000 g/mol and particularly preferably 1500 g/mol or more but less than 5000 g/mol. When the monomer S1 has a functional group equivalent of less than 700 g/mol, initial adhesive strength may not be sufficiently reduced. When the monomer S1 has a functional group equivalent of 15,000 g/mol or more, an increase of adhesive strength may be insufficient. When the monomer S1 has a functional group equivalent within the above range, compatibility (such as compatibility with the base polymer) and migration property in the PSA layer may be easily adjusted to appropriate ranges and it may be easy to obtain the PSA sheet achieving both low initial adhesiveness and strong adhesiveness upon use at higher levels.

The term “functional group equivalent” as used herein means the weight of the backbone (such as polydimethyl siloxane) bound per functional group. The indicated unit g/mol is based on 1 mol of the functional group. The functional group equivalent of the monomer S1 may be calculated from spectrum intensities of ¹H-NMR (proton NMR) based on nuclear magnetic resonance (NMR). The functional group equivalent (g/mol) of the monomer S1 based on spectrum intensities of ¹H-NMR may be calculated on the basis of general structural analysis according to ¹H-NMR spectrum analysis by, as needed, referring to the disclosure in Japanese Patent No. 5951153.

When two or more monomers having different functional group equivalents are used as the monomer S1, the arithmetic mean value may be regarded as the functional group equivalent of the monomer S1. Namely, the functional group equivalent of the monomer S1 containing n monomers (monomer S1₁, monomer S1₂ . . . monomer S1.) having different functional group equivalents may be calculated according to the following equation.

Functional group equivalent of monomer S1 (g/mol)=(functional group equivalent of monomer S1₁×amount of monomer S1₁+functional group equivalent of monomer S1₂×amount of monomer S1₂+ . . . +functional group equivalent of monomer S1ₙ×amount of monomer S1ₙ)/(amount of monomer S1₁+amount of monomer S1₂+ . . . +amount of monomer S1ₙ)

The content of the monomer S1 may be, for example, 5% by weight or more relative to all monomer components for preparation of the polymer Ps, and from the viewpoint of preferably exerting the effect as the adhesive strength rise retarder, the content is preferably 10% by weight or more and may be 15% by weight or more. In some embodiments, the content of the monomer S1 may be, for example, 20% by weight or more. The content of the monomer S1 is, from the viewpoint of polymerisation reactivity and compatibility, appropriately 60% by weight or less and may be 50% by weight or less, 40% by weight or less or 30% by weight or less relative to all monomer components for preparation of the polymer Ps. When the content of the monomer S1 is less than 5% by weight, initial adhesive strength may not be sufficiently reduced. When the content of the monomer S1 is more than 60% by weight, an increase of adhesive strength may be insufficient.

Monomer components for preparation of the polymer Ps may contain, in addition to the monomer S1, a (meth)acrylic monomer that is copolymerisable with the monomer S1 or another copolymerisable monomer, as needed. For example, by copolymerising one or two or more (meth)acrylic monomers with the monomer S1, compatibility of the polymer Ps with the base polymer (such as the acrylic polymer Pa) may be suitably adjusted.

Examples of the (meth)acrylic monomer include (meth)acrylic acid alkyl esters. For example, one or two or more monomers described above as the (meth)acrylic acid alkyl ester that may be used for the acrylic polymer Pa may be used. In some embodiments, the polymer Ps may contain as a monomer unit at least one of (meth)acrylic acid C₄₋₁₂ alkyl esters (preferably (meth)acrylic acid C₄₋₁₀ alkyl esters such as (meth)acrylic acid C₆₋₁₀ alkyl esters). In other embodiments, the polymer Ps may contain as a monomer unit at least one of methacrylic acid C₁₋₁₈ alkyl esters (preferably methacrylic acid C₁₋₁₄ alkyl esters such as methacrylic acid C₁₋₁₀ alkyl esters). The monomer units that form the polymer Ps may contain, for example, one or two or more selected from MMA, BMA and 2EHMA.

Other examples of the (meth)acrylic monomer include (meth)acrylic esters having an alicyclic hydrocarbon group. For example, cyclopentyl (meth)acrylate, cyclohexyl (meth)acrylate, isobornyl (meth)acrylate, dicyclopentanyl (meth)acrylate, 1-adamantyl (meth)acrylate or the like may be used. In some embodiments, the polymer Ps may contain as a monomer unit at least one selected from dicyclopentanyl methacrylate, isobornyl methacrylate and cyclohexyl methacrylate.

The amount of the (meth)acrylic acid alkyl ester and the (meth)acrylic ester having an alicyclic hydrocarbon group used may be, for example, 10% by weight or more and 95% by weight or less, 20% by weight or more and 95% by weight or less, 30% by weight or more and 90% by weight or less, 40% by weight or more and 90% by weight or less or 50% by weight or more and 85% by weight or less relative to all monomer components for preparation of the polymer Ps.

Other examples of the monomer that may be included as a monomer unit forming the polymer Ps in addition to the monomer S1 include the carboxyl group-containing monomers, the acid anhydride group-containing monomers, the hydroxy group-containing monomers, the epoxy group-containing monomers, the cyano group-containing monomers, the isocyanato group-containing monomers, the amido group-containing monomers, the monomers having a nitrogen atom-containing ring, the monomers having a succinimide skeleton, the maleimides, the itaconimides, the aminoalkyl (meth)acrylates, the vinyl esters, the vinyl ethers, the olefins, the (meth)acrylic esters having an aromatic hydrocarbon group, the heterocyclic ring-containing (meth)acrylates, the halogen atom-containing (meth)acrylates, the (meth)acrylic esters obtained from terpene compound derivative alcohols and the like exemplified above as monomers that may be used for the acrylic polymer Pa.

Other examples of the monomer that may be included as a monomer unit forming the polymer Ps in addition to the monomer S1 include oxyalkylene di(meth)acrylates such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate and tripropylene glycol di(meth)acrylate; polymerisable polyoxyalkylene ethers which have, at one terminal of the polyoxyalkylene chain of a monomer having a polyoxyalkylene skeleton such as polyethylene glycol and polypropylene glycol, a polymerisable functional group such as a (meth)acryloyl group, a vinyl group and an allyl and, at the other terminal, an ether structure (such as alkyl ether, aryl ether and aryl alkyl ether); alkoxyalkyl (meth)acrylates such as methoxyethyl (meth)acrylate, ethoxyethyl (meth)acrylate, propoxyethyl (meth)acrylate, butoxyethyl (meth)acrylate and ethoxypropyl (meth)acrylate; salts such as alkali metal (meth)acrylates; polyvalent (meth)acrylates such as trimethylolpropane tri(meth)acrylic ester: halogenated vinyl compounds such as vinylidene chloride and 2-chloroethyl (meth)acrylate; oxazoline group-containing monomers such as 2-vinyl-2-oxazoline, 2-vinyl-5-methyl-2-oxazoline and 2-isopropenyl-2-oxazoline; aziridine group-containing monomers such as (meth)acryloyl aziridine and 2-aziridinylethyl (meth)acrylate; hydroxy group-containing vinyl monomers such as 2-hydroxyethyl (meth)acrylate, 2-hydroxypropyl (meth)acrylate and addicts of a lactone and 2-hydroxyethyl (meth)acrylate; fluorine-containing vinyl monomers such as fluorine-substituted (meth)acrylic acid alkyl esters; reactive halogen-containing vinyl monomers such as 2-chloroethyl vinyl ether and vinyl monochloroacetate; organic silicon-containing vinyl monomers such as vinyltrimethoxysilane, γ-(meth)acryloxypropyl trimethoxysilane, allyltrimethoxysilane, trimethoxysilylpropylallylamine and 2-methoxyethoxytrimethoxysilane; and macromonomers having a radical polymerisable vinyl group at a monomer terminal obtained by polymerisation of vinyl groups and the like. The monomer that may be copolymerised with the monomer S1 may be one or more in combination.

In embodiments in which the monomer components for preparation of the polymer Ps include the monomer S1 and the (meth)acrylic monomer, the total amount of the monomer S1 and the (meth)acrylic monomer in the total monomer components may be, for example, 50% by weight or more, 70% by weight or more, 85% by weight or more, 90% by weight or more, 95% by weight or more or substantially 100% by weight.

The composition of the (meth)acrylic monomers in the monomer components may be configured so that the glass transition temperature Tₘₗ based on the composition of the (meth)acrylic monomers is higher than 0° C. The glass transition temperature Tₘₗ based on the composition of the (meth)acrylic monomers refers to Tg calculated from the Fox equation based on the composition of only the (meth)acrylic monomers in the monomer components for preparation of the polymer Ps. Tₘₗ may be determined by considering only the (meth)acrylic monomers among the monomer components for preparation of the polymer Ps, applying the Fox equation and calculating from glass transition temperatures of homopolymers of the respective (meth)acrylic monomers and the weight fractions of the (meth)acrylic monomers relative to the total amount of the (meth)acrylic monomers. According to the polymer Ps having a glass transition temperature Tₘₗ of higher than 0° C., initial adhesive strength may be easily reduced. According to the polymer Ps having a glass transition temperature Tₘₗ of higher than 0° C., a PSA sheet having high adhesive strength rise ratio may be easily obtained.

In some embodiments, Tₘₗ may be 10° C. or higher, 20° C. or higher, 30° C. or higher or 40° C. or higher. When Tₘₗ is increased, adhesive strength at an early stage of attachment tends to be preferably reduced in general. From the viewpoint of stably maintained low adhesiveness at an early stage of attachment, in some embodiments, Tₘₗ may be, for example, 50° C. or higher, 53° C. or higher, 56° C. or higher, 59° C. or higher, 62° C. or higher, 65° C. or higher, 68° C. or higher or 70° C. or higher. Tₘₗ may also be, for example, 120° C. or lower, 110° C. or lower, 100° C. or lower, 90° C. or lower, 85° C. or lower, 80° C. or lower or less than 80° C. When Tₘₗ is decreased, adhesive strength tends to be easily increased by heating. In some embodiments, Tₘₗ may be, for example, 75° C. or lower, 65° C. or lower or 55° C. or lower. The technique disclosed herein may be preferably exploited by using the polymer Ps having Tₘₗ in the range of, for example, 10° C. to 120° C., 20° C. to 110° C. or 30° C. to 100° C.

The polymer Ps may have any Mw without particular limitation. The polymer Ps may have Mw of, for example, 1000 or more or 5000 or more. The polymer Ps may also have Mw of, for example, 10×10⁴ or less or 7×10⁴ or less. In some embodiments, the polymer Ps may have Mw of, for example, 1×10⁴ or more but less than 5×10⁴, preferably 1.2×10⁴ or more but less than 5×10⁴, more preferably 1.5×10⁴ or more but less than 4×10⁴ and still more preferably 2×10⁴ or more but less than 4×10⁴. When the polymer Ps has Mw of less than 1×10⁴, an increase of adhesive strength may be insufficient. When the polymer Ps has Mw of 5×10⁴ or more, initial adhesive strength may not be sufficiently reduced. When the polymer Ps has Mw within the above range, compatibility and migration property in the PSA layer may be easily adjusted to appropriate ranges and it may be easy to obtain the PSA sheet achieving both low initial adhesiveness and strong adhesiveness upon use at higher levels.

The polymer Ps may be prepared by, for example, polymerising the monomers according to known manners such as solution polymerisation, emulsion polymerisation, bulk polymerisation, suspension polymerisation and photopolymerisation.

In order to adjust the molecular weight of the polymer Ps, a chain transfer agent may be used. Examples of the chain transfer agent used include mercapto group-containing compounds such as octyl mercaptan, lauryl mercaptan, t-nonyl mercaptan, t-dodecyl mercaptan, mercaptoethanol and a-thioglycerol; thioglycolic acid, and thioglycolic esters such as methyl thioglycolate, ethyl thioglycolate, propyl thioglycolate, butyl thioglycolate, t-butyl thioglycolate, 2-ethylhexyl thioglycolate, octyl thioglycolate, isooctyl thioglycolate, decyl thioglycolate, dodecyl thioglycolate, thioglycolic ester of ethylene glycol, thioglycolic ester of neopentyl glycol and thioglycolic ester of pentaerythritol; a-methylstyrene dimer; and the like.

The amount of the chain transfer agent used is not particularly limited. Generally, the chain transfer agent is included at, relative to 100 parts by weight of the monomers, 0.05 parts by weight to 20 parts by weight, preferably 0.1 parts by weight to 15 parts by weight and still more preferably 0.2 parts by weight to 10 parts by weight. By adjusting the amount of the chain transfer agent added, the polymer Ps having a suitable molecular weight may be obtained. The chain transfer agent used may be one or two or more in combination.

Without particular limitation, the amount of the polymer Ps used may be, relative to 100 parts by weight of the base polymer (such as the acrylic polymer Pa), for example, 0.1 parts by weight or more. The amount may be, from the viewpoint of obtaining a higher effect, 0.3 parts by weight or more, 0.4 parts by weight or more or 0.5 parts by weight or more. In some embodiments, the amount of the polymer Ps relative to 100 parts by weight of the base polymer may be 1 part by weight or more, 2 parts by weight or more or 3 parts by weight or more. From the viewpoint of preventing an excessive reduction of cohesive strength of the PSA layer, it is generally appropriate that the amount of the polymer Ps used relative to 100 parts by weight of the base polymer is 25 parts by weight or less, and from the viewpoint of obtaining higher post-heating adhesive strength, the amount is preferably 20 parts by weight or less, and may be 17 parts by weight or less, 15 parts by weight or less or 10 parts by weight or less. In some embodiments of the PSA sheet disclosed herein, the amount of the polymer Ps used relative to 100 parts by weight of the base polymer may be less than 10 parts by weight, 8 parts by weight or less, 5 parts by weight or less or less than 5 parts by weight, 4 parts by weight or less or 3 parts by weight or less.

The siloxane structure-containing polymer Ps added to the PSA layer may preferably serve as an adhesive strength rise retarder. The PSA sheet disclosed herein may be preferably exploited in an embodiment in which the PSA that forms the PSA layer contains the base polymer and the adhesive strength rise retarder and the adhesive strength rise retarder contains the polymer Ps. It is believed that the polymer Ps serves as the adhesive strength rise retarder as follows: in the PSA sheet before attachment to an adherend and at an early stage of attachment, the polymer Ps at the surface of the PSA layer reduces initial adhesive strength; and, after attachment the amount of the polymer Ps at the surface of the PSA layer decrease due to the PSA flows with the lapse of time or by heating, resulting in an increase of adhesive strength. Therefore, the abovementioned adhesive strength rise retarder in the technique disclosed herein may contain, alternative to or in addition to the polymer Ps, other materials that may exhibit similar functions. Non-limiting examples of such materials include a polymer (hereinafter also referred to as “polymer Po”) having a polyoxyalkylene structure in the molecule. The polymer Po may be, for example, a polymer containing a monomer unit derived from a monomer having a polyoxyalkylene skeleton. Specific examples of the polymer Po that may be used include homopolymers of one monomer type or copolymers of two or more monomers having a polyoxyalkylene skeleton described above, copolymers of one or two or more of monomers having a polyoxyalkylene skeleton and another monomer (such as a (meth)acrylic monomer) and the like. The amount of the monomer having a polyoxyalkylene skeleton used is not particularly limited. For example, the amount of the monomer S1 used in the polymer Ps may also be applied to the amount of the monomer having a polyoxyalkylene skeleton used in the polymer Po. The amount of the polymer Po used in the PSA layer is not particularly limited. For example, the amount of the polymer Ps relative to the base polymer described above may be applied to the amount of the polymer Po used relative to the base polymer. Alternatively, some (such as around 5% by weight to 95% by weight, around 15% by weight to 85% by weight or around 30% by weight to 70% by weight of the total amount of the polymer Ps used) of the polymer Ps relative to the base polymer may be replaced by the polymer Po.

(Crosslinking Agent)

The PSA layer disclosed herein may contain a crosslinking agent in order to adjust cohesive strength or the like. The crosslinking agent used may be any crosslinking agent generally used and examples thereof include epoxy crosslinking agents, isocyanate crosslinking agents, silicone crosslinking agent, oxazoline crosslinking agents, aziridine crosslinking agents, silane crosslinking agents, alkyl etherified melamine crosslinking agents, metal chelate crosslinking agent and the like. Particularly, an isocyanate crosslinking agent, an epoxy crosslinking agent or a metal chelate crosslinking agent may be suitably used. The crosslinking agent used may be one or two or more in combination.

Specifically, examples of the isocyanate crosslinking agent include tolylene diisocyanate, hexamethylene diisocyanate, isophorone diisocyanate, xylylene diisocyanate, hydrogenated xylylene diisocyanate, diphenyl(meth)ane diisocyanate, hydrogenated diphenyl(meth)ane diisocyanate, tetramethylxylylene diisocyanate, naphthalene diisocyanate, triphenyl(meth)ane triisocyanate, polymethylene polyphenyl isocyanate and adducts of the foregoing with a polyol such as trimethylolpropane. Alternatively, the isocyanate crosslinking agent that may be used is a compound having at least one isocyanato group and one or more unsaturated bonds in the molecule, specifically 2-isocyanatoethyl (meth)acrylate. The isocyanate crosslinking agent used may be one or two or more in combination.

Examples of the epoxy crosslinking agent include bisphenol A, epichlorohydrin-based epoxy resins, ethylene glycidyl ether, polyethylene glycol diglycidyl ether, glycerine diglycidyl ether, glycerine triglycidyl ether, 1,6-hexanediol glycidyl ether, trimethylolpropane triglycidyl ether, diglycidyl aniline, diamine glycidyl amine, N,N,N′,N′-tetraglycidyl-m-xylylene diamine and 1,3-bis(N,N-diglycidylaminomethyl)cyclohexane and the like. The epoxy crosslinking agent used may be one or two or more in combination.

Examples of the metal chelate compound include those containing a metal component such as aluminium, iron, tin, titanium and nickel and a chelate component such as acetylene, methyl acetoacetate and ethyl lactate. The metal chelate compound used may be one or two or more in combination.

The amount of the crosslinking agent used may be, for example, 0.01 parts by weight or more and preferably 0.05 parts by weight or more relative to 100 parts by weight of the base polymer. By increasing the amount of the crosslinking agent, cohesive strength tends to increase. In some embodiments, the amount of the crosslinking agent relative to 100 parts by weight of the base polymer may be 0.1 parts by weight or more, 0.5 parts by weight or more and 1 part by weight or more. Meanwhile, from the viewpoint of avoiding a reduction of tackiness due to an excessive increase of cohesive strength, it is generally appropriate that the amount of the crosslinking agent relative to 100 parts by weight of the base polymer is 15 parts by weight or less, and may be 10 parts by weight or less or 5 parts by weight or less. The amount of the crosslinking agent that is not excessively high in the PSA having the composition containing the siloxane structure-containing polymer Ps or another adhesive strength rise retarder may be advantageous also from the viewpoint of preferably exhibiting the effect due to use of the adhesive strength rise retarder by utilising flowability of the PSA.

The technique disclosed herein may be preferably exploited in an embodiment in which the crosslinking agent used is at least an isocyanate crosslinking agent. From the viewpoint of easily obtaining the PSA sheet having high post-heating cohesive strength and a high adhesive strength rise ratio, in some embodiments, the amount of the isocyanate crosslinking agent relative to 100 parts by weight of the base polymer may be, for example, 5 parts by weight or less, 3 parts by weight or less, less than 1 part by weight, 0.7 parts by weight or less or 0.5 parts by weight or less.

In order to effectively proceed any of the crosslinking reactions, a crosslinking catalyst may be used. The crosslinking catalyst preferably used may be, for example, a tin catalyst (particularly dioctyltin dilaurate). The amount of the crosslinking catalyst is not particularly limited, and may be approximately 0.0001 parts by weight to 1 part by weight relative to 100 parts by weight of the base polymer.

(Tackifier Resin)

The PSA layer may contain an tackifier resin, as needed. The tackifier resin may be, but is not limited to, a rosin-based tackifier resin, a terpene-based tackifier resin, a phenol-based tackifier resin, a hydrocarbon-based tackifier resin, a ketone-based tackifier resin, a polyamide-based tackifier resin, an epoxy-based tackifier resin, an elastomer -based tackifier resin and the like. The tackifier resin used may be one or two or more in combination.

From the viewpoint of reduction of the haze value, the amount of the tackifier resin is desirably 15 parts by weight or less, preferably 10 parts by weight or less, more preferably 5 parts by weight or less, still more preferably 3 parts by weight or less and may be 1 part by weight or less (such as 0.5 parts by weight or less) relative to 100 parts by weight of the base polymer. The technique disclosed herein may be preferably exploited in an embodiment in which the tackifier resin is not substantially used (for example, an embodiment in which the content of the tackifier resin relative to 100 parts by weight of the base polymer is less than 0.1% by weight).

The PSA layer in the technique disclosed herein may contain, as needed, known additives that may be used for PSAs such as a levelling agent, a plasticiser, a softening agent, a colorant (such as dye and pigment), a filler, an antistatic agent, an ageing inhibitor, an ultraviolet absorbing agent, an antioxidant, a light stabiliser and a preservative within the range that does not significantly inhibit the effect of the present invention.

(Formation of the PSA Layer)

The PSA layer included in the PSA sheet disclosed herein may be a cured layer of a PSA composition. Namely, the PSA layer may be formed by providing (such as applying) the PSA composition on an appropriate surface followed by appropriately providing curing treatment. When two or more different curing treatments (such as drying, crosslinking and polymerisation) are performed, the treatments may be performed simultaneously or in multiple stages. For the PSA composition containing a partial polymerisation product (acrylic polymer syrup) of monomer components, the curing treatment typically performed is a final copolymerisation reaction. Namely, the partial polymerisation product is subjected to further copolymerisation reaction to form a full polymerisation product. For example, for a photocurable PSA composition, light irradiation is performed. As needed, curing treatments such as crosslinking and drying may be performed. For example, in case a photocurable PSA composition requires drying, photocuring may be performed after drying. For a PSA composition containing a full polymerisation product, the curing treatment performed as needed typically includes drying (drying by heating), crosslinking and the like.

The PSA composition may be applied with, for example, a conventional coater such as a gravure roll coater, a reverse roll coater, a kiss-roll coater, a dip roll coater, a bar coater, a knife coater and a spray coater.

In the PSA sheet with a substrate, the PSA layer may be provided on the surface of the substrate by a direct method in which the PSA composition is directly provided on the substrate to form a PSA layer, by a transfer method in which a PSA layer formed on a surface having release ability (release surface) is transferred onto the substrate, or by combination of the methods. The release surface utilised may be, for instance, a surface of a release liner, and a back surface of a substrate treated to have release ability.

Without particular limitation, it is generally appropriate that the gel fraction of the PSA that forms the PSA layer is in the range of 20.0% to 99.0% and desirably in the range of 30.0% to 90.0%. By configuring the gel fraction so as to be in the above range, a PSA sheet achieving both low initial adhesiveness and strong adhesiveness upon use at higher levels may be easily achieved. The gel fraction may be measured according to the method indicated below.

[Measurement of Gel Fraction]

About 0.1 g of PSA sample (weight: Wg₁) is wrapped with a porous polytetrafluoroethylene film (weight: Wg₂) having an average pore diameter of 0.2 μm so as to form the shape of a drawstring bag and the opening is tied with a string (weight: Wg₃). The porous polytetrafluoroethylene film used is product name “NITOFLON® NTF1122” (Nitto Denko Corporation, average pore diameter: 0.2 μm, porosity: 75%, thickness: 85 μm) or an equivalent thereof. The pack is immersed in 50 mL of ethyl acetate and maintained at room temperature (typically 23° C.) for 7 days to allow elution of the sol content (ethyl acetate soluble content) in the PSA into outside of the film. The pack is then removed, ethyl acetate on the outer surface is wiped off, the pack is dried at 130° C. for 2 hours and the pack is weighed (Wg₄). The values are substituted into the following equation, thereby calculating the gel fraction G_{C} of the PSA.

Gel fraction G_{C}(%)=[(Wg₄−Wg₂−Wg₃)/Wg₁]×100

The PSA layer may have any thickness without particular limitation and may have a thickness of, for example, 1 μm or more. Generally, a PSA layer having a thickness of 3 μm or more (such as 5 μm or more) may achieve preferable bonding. In some embodiments, the PSA layer may have a thickness of 8 μm or more, 10 μm or more or 13 μm or more. By increasing the thickness of the PSA layer, post-heating adhesive strength may be easily improved. From the viewpoint of reduction of the haze value, it is advantageous that the PSA layer has a thickness of 100 μm or less, it is generally appropriate that the thickness is 80 μm or less, and may be 60 μm or less, 50 μm or less or 40 μm or less. In some embodiments, the PSA layer may have a thickness of 35 μm or less, 30 μm or less, 25 μm or less, 20 μm or less or 18 μm or less. In the case of double-sided PSA sheet with a substrate including PSA sheets on either side of the substrate, the thickness of the PSA layer corresponds to the thickness of the PSA layer per side of the substrate.

(Haze Value)

In the technique disclosed herein, the PSA layer preferably has a haze value of approximately 1.0% or less. The PSA sheet including the PSA layer having such high transparency is suitable for applications for which high optical transparency is required or applications required to have good visibility of an adherend through the PSA sheet either in the configuration with or without a substrate. In the structure with a substrate, the PSA sheet is suitable for applications required to have good visibility of exterior appearance of the substrate through the PSA layer. In some embodiments, the PSA layer may have a haze value of less than 1.0%, 0.9% or less, 0.8% or less, 0.7% or less or less than 0.7%. The haze value in the context of the PSA layer may be preferably applied to the haze value of the PSA sheet when the technique disclosed herein is exploited in the form of the substrate-free PSA sheet.

As used herein, the term “haze value” or cloudiness value refers to the proportion of diffuse transmitted light relative to total transmitted light when an object to be measured is irradiated with visible light. The haze value may be represented by the following formula.

Th (%)=Td/Tt×100

In the formula, Th is haze value (%), Td is scattered light transmission and Tt is total light transmission. The haze value may be measured according to the method described in Examples hereinbelow. The haze value may be adjusted by, for example, selection of the composition or thickness of the PSA layer.

The PSA layer disclosed herein preferably contains monomer units derived from (meth)acrylic monomers at a proportion of above 50% by weight in total monomer units in the PSA layer. The PSA layer containing (meth)acrylic monomers at the above proportion may easily have low haze value. It is also preferable from the viewpoint of facilitating adjustment of adhesive properties by the composition of (meth)acrylic monomers. Therefore, according to the PSA layer containing (meth)acrylic monomers at the above proportion, a PSA sheet having low haze value, low initial adhesive strength and high post-heating adhesive strength may be suitably obtained. The proportion of monomer units derived from (meth)acrylic monomers in total monomer units in the PSA layer may be, for example, 60% by weight or more, 70% by weight or more or 80% by weight or more. In some embodiments, the proportion may be 90% by weight or more, 95% by weight or more or 98% by weight or more. From the viewpoint of adjustment of adhesive properties (such as improvement of cohesive strength) and the like, the proportion in some embodiments may be 99% by weight or less, less than 95% by weight or less than 90% by weight.

From the viewpoint of reduction of the haze value, the amount of the monomer S1 (monomer having a polyorganosiloxane skeleton) when used is appropriately 10% by weight or less, preferably 5% by weight or less, more preferably 3% by weight or less, and may be 2% by weight or less (such as 1.5% by weight or less) of total monomer units in the PSA layer. From the viewpoint of reduction of initial adhesive strength and improvement of the adhesive strength rise ratio, the amount of the monomer S1 used is appropriately 0.05% by weight or more, preferably 0.1% by weight or more and more preferably 0.3% by weight or more (such as 0.5% by weight or more or 0.7% by weight or more) of total monomer units in the PSA layer.

Without particular limitation, when the isocyanate crosslinking agent is used in the configuration in which the PSA layer contains, as a monomer unit, a hydroxy group-containing monomer, the amount W_{OH} of the hydroxy group-containing monomer used relative to the amount W_{NCO} of the isocyanate crosslinking agent may be such that W_{OH}/W_{NCO} on the weight basis is 2 or more. By increasing the amount of the hydroxy group-containing monomer relative to the isocyanate crosslinking agent, the crosslinking structure that is suitable for an improvement of transparency and the adhesive strength rise ratio may be formed. In some embodiments, W_{OH}/W_{NCO} may be 3 or more, 5 or more, 10 or more, 20 or more, 30 or more or 50 or more. The upper limit of W_{OH}/W_{NCO} is not particularly restricted. W_{OH}/W_{NCO} may be, for example, 500 or less, 200 or less or 100 or less.

In the configuration in which the PSA layer contains the base polymer (such as the acrylic polymer) and the polymer Ps, inclusion of a monomer unit which is in common with the monomer unit in the polymer Ps to the base polymer may improve compatibility of the base polymer with polymer Ps and may reduce the haze value. The common monomer units are effectively components that account for 5% by weight or more of total monomer units in the polymer Ps, and preferably components that account for 10% by weight or more (more preferably 20% by weight or more such as 30% by weight or more). The proportion of the common monomer units in total monomer units in the base polymer may be, for example, 1% by weight or more and preferably 3% by weight or more, more preferably 5% by weight or more or 7% by weight or more. When the proportion of the common monomer units in total monomer units in the base polymer is increased, the effect of compatibility improvement tends to be more preferably exhibited. By taking the balance between other properties into account, the proportion of the common monomer units in total monomer units in the base polymer may be 50% by weight or less or 30% by weight or less. Non-limiting examples of monomers that are preferably employed as the common monomer units include MMA, BMA, 2EHMA, methyl acrylate (MA), BA, 2EHA, cyclohexyl (meth)acrylate, isobornyl (meth)acrylate, dicyclopentanyl (meth)acrylate and the like.

<Support Substrate>

The technique disclosed herein may be exploited in the form of PSA sheet with a substrate including a PSA layer on one or either side of a support substrate. The material of the support substrate is not particularly limited and may be appropriately selected according to the purpose of use, mode of usage or the like of the PSA sheet. Non-limiting examples of the substrate that may be used include plastic films including polyolefin films mainly containing polyolefin such as polypropylene and ethylene-propylene copolymers, polyester films mainly containing polyester such as polyethylene terephthalate and polybutylene terephthalate and polyvinyl chloride films mainly containing polyvinyl chloride; foam sheets formed with foams such as polyurethane foams, polyethylene foams and polychloroprene foams; woven and nonwoven cloth of single or blended spinning of various fibrous materials (which may be natural fibres such as hemp and cotton, synthetic fibres such as polyester and vinylon, semi-synthetic fibres such as acetate, etc.); paper such as Japanese paper, high-quality paper, kraft paper and crepe paper; metal foils such as aluminium foils and copper foils; and the like. The substrate may be a composite of the foregoing materials. Examples of the composite substrate include a substrate having a structure including a metal foil and a plastic film laminated together, a plastic substrate reinforced with an inorganic fibre such as glass cloth, and the like.

The substrate of the PSA sheet disclosed herein which may be preferably used is any of various film substrates. The film substrate may be a porous substrate such as a foam film or a nonwoven cloth sheet, or a non-porous substrate, or a substrate having a structure that includes a porous layer and a non-porous layer laminated together. In some embodiments, the film substrate which may be preferably used is one including a resin film that can independently maintain the shape (self-standing or independent) as a base film. The term “resin film” as used herein means a resin film that has a non-porous structure and typically does not substantially contain gas bubbles (i.e. voidless structure). Therefore, the resin film is a concept that is different from a foam film or nonwoven cloth. The resin film may have a single layer structure or a multilayer structure with two or more layers (such as three-layer structure).

Examples of a resin material that forms the resin film include resins including polyester, polyolefin, polyamide (PA) such as nylon 6, nylon 66 and partially aromatic polyamide, polyimide (PI), polyamideimide (PAI), polyether ether ketone (PEEK), polyether sulphone (PES), polyphenylene sulphide (PPS), polycarbonate (PC), polyurethane (PU), ethylene-vinyl acetate copolymers (EVA), fluororesins such as polytetrafluoroethylene (PTFE), acrylic resins, polyacrylate, polystyrene, polyvinyl chloride, polyvinylidene chloride and the like. The resin film may be formed from a resin material containing one single resin or may be formed from a resin material containing blended two or more resins. The resin film may be non-stretched or stretched (such as uniaxial stretched or biaxial stretched).

Suitable examples of the resin material that forms the resin film include polyester resins, PPS resins and polyolefin resins. The polyester resin refers to a resin containing more than 50% by weight of polyester. Similarly, the PPS resin refers to a resin containing more than 50% by weight of PPS and the polyolefin resin refers to a resin containing more than 50% by weight of polyolefin.

The polyester resin typically used is a polyester resin mainly containing a polyester obtained by polycondensation of a dicarboxylic acid and a diol.

Examples of the dicarboxylic acid that forms the polyester include aromatic dicarboxylic acids such as phthalic acid, isophthalic acid, terephthalic acid, 2-methylterephthalic acid, 5-sulphoisophthalic acid, 4,4′-diphenyl-dicarboxylic acid, 4,4′-diphenyl ether dicarboxylic acid, 4,4′-diphenyl ketone dicarboxylic acid, 4,4′-diphenoxyethane dicarboxylic acid, 4,4′-diphenylsulphone dicarboxylic acid, 1,4-naphthalenedicarboxylic acid, 1,5-naphthalenedicarboxylic acid, 2,6-naphthalenedicarboxylic acid and 2,7-naphthalenedicarboxylic acid; alicyclic dicarboxylic acids such as 1,2-cyclohexanedicarboxylic acid, 1,3-cyclohexanedicarboxylic acid and 1,4- cyclohexanedicarboxylic acid; aliphatic dicarboxylic acids such as malonic acid, succinic acid, glutaric acid, adipic acid, pimelic acid, suberic acid, azelaic acid, sebacic acid and dodecanoic acid; unsaturated dicarboxylic acids such as maleic acid, maleic anhydride and fumaric acid; derivatives thereof (such as lower alkyl esters of the dicarboxylic acids such as terephthalic acid); and the like. The dicarboxylic acid used may be one or two or more in combination. Because the substrate exhibiting suitable elastic modulus Es′ in the technique disclosed herein may be easily obtained, aromatic dicarboxylic acids are preferred. Among others, suitable dicarboxylic acids include terephthalic acid and 2,6-naphthalenedicarboxylic acid. For example, it is preferable that 50% by weight or more (such as 80% by weight or more, typically 95% by weight or more) of the dicarboxylic acids that form the polyester are terephthalic acid, 2,6-naphthalenedicarboxylic acid or combination thereof. The dicarboxylic acids may substantially include only terephthalic acid, substantially include only 2,6-naphthalenedicarboxylic acid or substantially include only terephthalic acid and 2,6-naphthalenedicarboxylic acid.

Examples of the diol that forms the polyester include aliphatic diols such as ethylene glycol, diethylene glycol, polyethylene glycol, propylene glycol, polypropylene glycol, 1,3-propanediol, 1,5-pentanediol, neopentyl glycol, 1,4-butanediol, 1,6-hexanediol, 1,8-octanediol and polyoxytetramethylene glycol; alicyclic diols such as 1,2-cyclohexanediol, 1,4-cyclohexanediol, 1,1-cyclohexanedimethylol and 1,4-cyclohexanedimethylol; aromatic diols such as xylylene glycol, 4,4′-dihydroxybiphenyl, 2,2-bis(4′-hydroxyphenyl)propane and bis(4-hydroxyphenyl)sulphone; and the like. The diol used may be one or two or more in combination. Among others, aliphatic diols are preferred from the viewpoint of transparency and the like, and ethylene glycol is particularly preferred from the viewpoint of elastic modulus Es′ of the substrate. It is preferable that the diols that form the polyester contain 50% by weight or more (such as 80% by weight or more, typically 95% by weight or more) of the aliphatic diols (preferably, ethylene glycol). The diols may substantially include only ethylene glycol.

Specific examples of the polyester resin include polyethylene terephthalate (PET), polybutylene terephthalate (PBT), polyethylene naphthalate (PEN), polybutylene naphthalate and the like.

The polyolefin resin used may be only one polyolefin or two or more polyolefins in combination. The polyolefin may be, for example, a homopolymer of an α-olefin, a copolymer of two or more α-olefins, a copolymer of one or two or more α-olefins and another vinyl monomer or the like. Specific examples thereof include polyethylene (PE), polypropylene (PP), poly-1-butene, poly-4-methyl-1-pentene, ethylene-propylene copolymers such as ethylene-propylene rubber (EPR), ethylene-propylene-butene copolymers, ethylene-butene copolymers, ethylene-vinyl alcohol copolymers, ethylene-ethyl acrylate copolymers and the like. Either low-density (LD) polyolefin or high-density (HD) polyolefin may be used. Examples of the polyolefin resin film include non-stretched polypropylene (CPP) films, biaxial stretched polypropylene (OPP) films, low-density polyethylene (LDPE) films, linear low-density polyethylene (LLDPE) films, medium-density polyethylene (MDPE) films, high-density polyethylene (HDPE) films, polyethylene (PE) films formed from a blend of two or more polyethylenes (PEs), PP/PE blend films formed from a blend of polypropylene (PP) and polyethylene (PE), and the like.

Specific examples of the resin film that may be preferably used for the substrate of the PSA sheet disclosed herein include PET films, PEN films, PPS films, PEEK films, CPP films and OPP films. Examples that are preferable from the viewpoint of obtaining suitable Et′×(Ts)³ in a thin substrate include PET films, PEN films, PPS films and PEEK films. From the viewpoint of availability of the substrate, PET films and PPS films are particularly preferred and, among others, PET films are preferred.

The resin film may contain, as needed, a known additive such as a light stabilizer, an antioxidant, an antistatic agent, a colorant (such as dye and pigment), a filler, a slip agent and an anti-blocking agent within the range that does not significantly inhibit the effect of the present invention. The amount of the additive is not particularly limited and may be appropriately selected according to the application of the PSA sheet and the like.

The production method of the resin film is not particularly limited. Conventionally known resin film formation methods such as extrusion moulding, inflation moulding, T-die casting and calendaring may be appropriately employed.

The substrate may be one that is substantially formed from such a base film. Alternatively, the substrate may contain an auxiliary layer in addition to the base film. Examples of the auxiliary layer include a layer for adjusting optical properties (such as a colouring layer and an antireflection layer), a printing layer and laminate layer for imparting desired appearance to the substrate, a surface treatment layer such as an antistatic layer, an undercoat layer, a release layer and the like.

The first surface of the substrate may be subjected to, as needed, conventionally known surface treatment such as corona discharge treatment, plasma treatment, ultraviolet irradiation treatment, acid treatment, alkaline treatment, application of a primer and antistatic treatment. The surface treatment may be a treatment for improving tight adhesiveness between the substrate and the PSA layer, in other words, anchoring of the PSA layer to the substrate. The primer may have any composition without particular limitation and may be selected from well-known primers. The thickness of the undercoat is not particularly limited and it is generally appropriate that the thickness is around 0.01 μm to 1 μm and preferably around 0.1 μm to 1 μm.

In case of a one-sided PSA sheet, the second surface of the substrate may be subjected to, as needed, conventionally well-known surface treatment such as peeling treatment and antistatic treatment. For example, by treating a back surface of the substrate with a release agent (typically providing a release layer with a release agent), unwinding force of the wound PSA sheet in the form of roll may be reduced. The release agent which may be used is a silicone release agent, a long chain alkyl release agent, an olefin release agent, a fluorine release agent, a fatty acid amide release agent, molybdenum sulphide, silica powder and the like. In order to improve printing ability, reduce light reflection, improve an ability of overlaying and the like, the second surface of the substrate may also be subjected to a treatment such as corona discharge treatment, plasma treatment, ultraviolet irradiation treatment, acid treatment and alkaline treatment. In case of a double-sided PSA sheet, the second surface of the substrate may be subjected to, as needed, the same surface treatment exemplified as surface treatments that may be performed on the first surface of the substrate. The first surface and the second surface of the substrate may be subjected to the same surface treatment or different surface treatments.

The substrate included in the PSA sheet disclosed herein may be or may not be transparent. The term “transparent” as used herein means to encompass colourless-transparent, and coloured-transparent. For example, a transparent (typically colourles-transparent) resin film may be preferably employed as the substrate.

In some embodiments, the substrate may have a haze value of, for example, 90% or less, 70% or less, 50% or less or 25% or less. The substrate having low haze value is suitable for applications for which high optical transparency of the PSA sheet is required or applications required to have good visibility of an adherend through the PSA sheet. From such a viewpoint, the substrate may have a haze value of 10% or less or 5% or less. The lower limit of the haze value of the substrate is not particularly restricted and may be, for example, 0.1% or more, 0.5% or more or 1% or more.

The substrate included in the PSA sheet disclosed herein may have any thickness without particular limitation and the thickness may be appropriately selected according to the purpose of use, mode of usage and the like of the PSA sheet. The substrate (such as a film substrate) may have a thickness of, for example, 2 μm or more, 5 μm or more, 10 μm or more, 20 μm or more or 25 μm or more. In some embodiments, the substrate may have a thickness of, for example, above 25 μm, 30 μm or more, 35 μm or more, 40 μm or more, 50 μm or more (such as above 50 μm), 60 μm or more or 70 μm or more. The PSA sheet disclosed herein may be suitably exploited in an embodiment in which the substrate has a thickness of 90 μm or more, 100 μm or more or 120 μm or more. The upper limit of the thickness of the substrate is not particularly restricted. The technique disclosed herein may be exploited in an embodiment in which the substrate has a thickness of, for example, 4.5 mm or less (such as 2.5 mm or less). In some embodiments, from the viewpoint of handling and processing properties of the PSA sheet, the substrate may have a thickness of 900 μm or less, 500 μm or less, 300 μm or less, 250 μm or less or 200 μm or less. In some other embodiments, the substrate may have a thickness of 160 μm or less, 130 μm or less, 100 μm or less or 90 μm or less.

The elastic modulus Es′ of the substrate is not particularly limited and may be, for example, 300 MPa or more or 500 MPa or more. In some embodiments, the substrate having Es′ of 1000 MPa or more (such as 1500 MPa or more or 2000 MPa or more) may be preferably employed. The upper limit of Es′ is not particularly restricted. From the viewpoint of availability and ease of manufacture of the substrate, it is generally appropriate that Es′ is 30,000 MPa or less, preferably 20,000 MPa or less and more preferably 10,000 MPa or less (such as 6000 MPa or less). The elastic modulus Es′ of the substrate may be measured in the same manner as the elastic modulus Et′ of the PSA sheet as described hereinbelow except that the substrate cut into a strip of a length of 30 mm and a width of 5 mm is used as a sample. The elastic modulus Es′ of the substrate may be adjusted by the configuration or materials of the substrate, combinations thereof and the like.

The PSA sheet disclosed herein may be suitably exploited in an embodiment in which the thickness Ts of the support substrate is higher than the thickness Ta of the PSA layer. Namely, Ts/Ta is preferably more than 1. Without particular limitation, Ts/Ta may be, for example, 1.1 or more, 1.2 or more, 1.5 or more or 1.7 or more. By increasing Ts/Ta, the PSA sheet achieving both low initial adhesiveness and strong adhesiveness upon use at higher levels tends to be easily obtained. In some embodiments, Ts/Ta may be 2 or more (such as above 2), 3 or more or 4 or more. Ts/Ta may be, for example, 50 or less or 20 or less. In some embodiments, Ts/Ta may be, for example, 10 or less or 8 or less from the viewpoint of facilitating exhibition of preferable post-heating adhesive strength even with the PSA sheet having a reduced thickness.

<PSA Sheet>

The PSA sheet disclosed herein is characterised in that, in addition to that the PSA layer has excellent transparency, the PSA sheet exhibits low initial adhesive strength and high post-heating adhesive strength. The initial adhesive strength may be, for example, approximately 1.5 N/20 mm or less. The post-heating adhesive strength may be, for example, approximately 10.0 N/20 mm or more. The initial adhesive strength may be evaluated by press-bonding the PSA sheet onto an adherend, a stainless steel (SUS) plate, which is then left to stand in an environment of 23° C. and 50% RH for 30 minutes followed by measurement of 180° -peel adhesive strength under conditions of the peeling angle of 180 degrees and the tensile speed of 300 mm/minute. The post-heating adhesive strength may be evaluated by press-bonding the PSA sheet to an adherend, a SUS plate, heating at 80° C. for 5 minutes and leaving the same in an environment of 23° C. and 50% RH for 30 minutes followed by measurement of 180° -peel adhesive strength under conditions of the peeling angle of 180 degrees and the tensile speed of 300 mm/minute. The adherend used for measurements of both initial adhesive strength and post-heating adhesive strength is a SUS304BA plate. More specifically, the initial adhesive strength and the post-heating adhesive strength may be measured according to the methods described in Examples hereinbelow. Upon measurements, the PSA sheet to be measured may be, as needed, attached to an appropriate backing material (such as a PET film having a thickness of about 25 μm) for reinforcement. The same applies to the cohesive strength test described hereinbelow.

The initial adhesive strength of the PSA sheet disclosed herein is typically 1.5 N/20 mm or less, and it is generally preferable that the initial adhesive strength is 1.2 N/20 mm or less. When the initial adhesive strength is decreased, the PSA sheet generally tends to exhibit improved reworkability. From such a viewpoint, the initial adhesive strength in some embodiments may be 1.0 N/20 mm or less (such as less than 1.0 N/20 mm), 0.8 N/20 mm or less or 0.6 N/20 mm or less. The lower limit of the initial adhesive strength is not particularly restricted and may be, for example, 0.01 N/20 mm or more. From the viewpoint of attachment workability to an adherend, it is generally appropriate that the initial adhesive strength is 0.05 N/20 mm or more. In some embodiments, the initial adhesive strength may be 0.1 N/20 mm or more, 0.2 N/20 mm or more or, for example, 0.3 N/20 mm or more. The initial adhesive strength that is not extremely low may be advantageous from the viewpoint of positioning upon attachment and tight adhesiveness (such as contour-following ability) to the surface of an adherend. The initial adhesive strength that is not extremely low is also preferable from the viewpoint of preventing occurrence of displacement after attachment before an increase of adhesive strength.

The post-heating adhesive strength of the PSA sheet disclosed herein may be typically 10 N/20 mm or more and, for example, 12 N/20 mm or more. Exhibition of higher post-heating adhesive strength is preferable from the viewpoint of improvement in joining reliability after an increase of adhesive strength (such as upon use of an adherend). In some embodiments, the post-heating adhesive strength may be 15 N/20 mm or more, 18 N/20 mm or more or 20 N/20 mm or more. The upper limit of the post-heating adhesive strength is not particularly restricted. From the viewpoint of ease of manufacture of the PSA sheet and economic efficiency, the post-heating adhesive strength in some embodiments may be, for example, 50 N/20 mm or less or 40 N/20 mm or less. The PSA sheet disclosed herein may be suitably exploited in an embodiment in which the post-heating adhesive strength is 30 N/20 mm or less (such as 25 N/20 mm or less or 20 N/20 mm or less).

The PSA sheet disclosed herein may have a ratio of the post-heating adhesive strength to the initial adhesive strength (adhesive strength rise ratio) of, for example, 5 or more. From the viewpoint of achieving both low initial adhesiveness and strong adhesiveness upon use at higher levels, the adhesive strength rise ratio is preferably 10 or more, more preferably 20 or more and still more preferably 30 or more. In some embodiments, the adhesive strength rise ratio may be 35 or more, 40 or more or 45 or more. The upper limit of the adhesive strength rise ratio is not particularly restricted. From the viewpoint of ease of manufacture of the PSA sheet and economic efficiency, the adhesive strength rise ratio may be, for example, 100 or less, 80 or less, 70 or less or 50 or less (such as about 15 to 50). The PSA sheet disclosed herein may be suitably exploited in an embodiment in which the adhesive strength rise ratio is 40 or less (such as 30 or less).

The post-heating adhesive strength of the PSA sheet disclosed herein represents one property of the PSA sheet and does not limit the mode of usage of the PSA sheet. In other words, the mode of usage of the PSA sheet disclosed herein is not limited to an embodiment in which heating is carried out at 80° C. for 5 minutes. The PSA sheet disclosed herein may be used in an embodiment, for example, in which a heating treatment to or above room temperature region (generally 20° C. to 30° C., typically 23° C. to 25° C.) is not particularly carried out. Even in such mode of usage, the adhesive strength may increase over a long period of time and strong joining may be obtained. The PSA sheet disclosed herein may be subjected to heat treatment at any timing after attachment in order to promote an increase of adhesive strength. The heating temperature during the heat treatment is not particularly limited and may be selected by taking into consideration workability, economic efficiency, heat resistance of the substrate of the PSA sheet or an adherend. The heating temperature may be, for example, lower than 150° C., 120° C. or lower, 100° C. or lower, 80° C. or lower or 70° C. or lower. The heating temperature may be, for example, 35° C. or higher, 50° C. or higher or 60° C. or higher and may be 80° C. or higher or 100° C. or higher. A higher heating temperature may increase adhesive strength by the treatment over a shorter time. The heating duration is not particularly limited and may be, for example, 1 hour or less, 30 minutes or less, 10 minutes or less or 5 minutes or less. Alternatively, a longer heating treatment may be performed as far as the PSA sheet or the adherend does not have significant heat deterioration generated. The heating treatment may be performed once or more than once.

Without particular limitation, the PSA sheet disclosed herein in some embodiments may have a displacement distance in a cohesive strength test of 1.0 mm or less, wherein in the test, the PSA sheet is attached to a bakelite plate at an attachment area of a width of 10 mm and a length of 20 mm and 30 minutes later, a load of 500 g is applied in the shear direction along the length in an environment of 40° C. and retained for 30 minutes. According to the PSA sheet that exhibits preferable shear displacement resistance even at an early stage after attachment, displacement after attachment may be inhibited and a component may be fixed with preferable positional precision. In a preferable embodiment, the displacement distance may be 0.7 mm or less, less than 0.5 mm or less than 0.3 mm. The PSA sheet disclosed herein may be suitably exploited in an embodiment, for example, in which the initial adhesive strength is 1.0 N/20 mm or less and the displacement distance in the cohesive strength test is 1.0 mm or less (preferably less than 0.5 mm). The PSA sheet has preferable reworkability due to low adhesive strength at an early stage after attachment, and is excellent in preventing displacement for exhibiting preferable shear displacement resistance. The cohesive strength test may be, more specifically, carried out according to the method described in Examples hereinbelow.

As an index of low adhesive strength at an early stage after attachment along with high shear displacement resistance, a product of a value (namely, a dimensionless value corresponding to the initial adhesive strength expressed by the unit of N/20 mm) of the initial adhesive strength (N/20 mm) and a value (namely, a dimensionless value corresponding to the displacement distance expressed by the unit of mm) of the displacement distance (mm) in the cohesive strength test may be used. In some embodiments of the PSA sheet disclosed herein, the product of the value of the initial adhesive strength (N/20 mm) and the value of the displacement distance (mm) may be, for example, 0.25 or less, 0.20 or less or 0.15 or less. A PSA sheet having lower initial adhesive strength and higher shear displacement resistance tends to produce a product that is smaller. The lower limit of the value of the product is not particularly restricted. From the viewpoint of adhesiveness to a curved surface and the like, the value may be, for example, 0.005 or more or 0.01 or more.

When the PSA sheet disclosed herein is in the form of PSA sheet with a substrate including a PSA layer on one or either side of the support substrate, the PSA sheet may or may not be transparent. In some embodiments, the PSA sheet may have a haze value of, for example, 90% or less, 70% or less, 50% or less, 25% or less, 10% or less or 5% or less. The lower limit of the haze value of the PSA sheet is not particularly restricted, and may be, for example, 0.1% or more, 0.5% or more or 1% or more.

In some embodiments, the relationship between the elastic modulus Et′ [MPa] of the PSA sheet and the thickness Ts [mm] of the substrate included in the PSA sheet preferably fulfils 0.1 [N·mm]<Et′×(Ts)³. The value Et′×(Ts)³ is proportional to the bending rigidity of the PSA sheet. Thus, an increased value of Et′×(Ts)³ of the PSA sheet means an increased bending rigidity of the PSA sheet or the PSA sheet being less flexible. Specifically, by configuring so that the bending rigidity of the PSA sheet is at or above a certain level, specifically so that Et′×(Ts)³ is above 0.1 N·mm, the PSA sheet fulfilling the initial adhesive strength and post-heating adhesive strength as disclosed herein tends to be easily obtained.

In some embodiments, Et′×(Ts)³ of the PSA sheet may be 0.25 N·mm or more, 0.5 N·mm or more, 0.7 N·mm or more or 0.9 N·mm or more. The PSA sheet disclosed herein may be suitably exploited in an embodiment in which Et′×(Ts)³ is 2.0 N·mm or more, 3.0 N·mm or more or 4.0 N·mm or more. The upper limit of Et′×(Ts)³ is not particularly restricted. From the viewpoint of handling and processing properties of the PSA sheet, it is generally appropriate that Et′×(Ts)³ is approximately 100 N·mm or less and preferably about 50 N·mm or less (such as 20 N·mm or less).

The elastic modulus Et′ of the PSA sheet may be measured on a commercially available dynamic viscoelasticity analyser. Specifically, a sample (PSA sheet) to be measured is cut into a strip of a length of 30 mm and a width of 5 mm to prepare a test strip. The test strip is measured on a dynamic viscoelasticity analyser (produced by TA Instruments, RSA-III) for tensile storage modulus in a temperature region of 0° C. to 100° C. as a value per cross-sectional area of the substrate in a tensile measurement mode under conditions of the distance between chucks of 23 mm, the heating rate of 10° C./minute, the frequency of 1 Hz and the strain of 0.05%. From the result, the tensile storage modulus per cross-sectional area of the substrate at 25° C. may be determined. This value is regarded as the elastic modulus Et′ of the PSA sheet.

The reason for determining the elastic modulus Et′ of the PSA sheet as a value “per cross-sectional area of the substrate” is that when the cross-sectional area used for calculation of the tensile storage modulus includes the cross-sectional area of the PSA layer, it would be rather difficult to understand the properties of the PSA sheet suitable for the purpose of the present application because the PSA has such low elastic modulus compared to the elastic modulus of the substrate that could be disregarded (typically, less than 1% of the elastic modulus of the substrate). In addition, because the PSA has extremely low elastic modulus compared to the elastic modulus of the substrate, the elastic modulus determined according to the above method using the PSA sheet as a sample (namely, tensile storage modulus Et′ per cross-sectional area of the substrate) and the elastic modulus Es′ (Es′ may be measured in the same manner as Et′ except that the substrate cut into a strip of a length of 30 mm and a width of 5 mm is used as a sample) of the substrate may also generally be regarded to be equivalent from the viewpoint of solving the problem of the present invention. Accordingly, in the art disclosed herein, the elastic modulus Es′ of the substrate may serve as an alternate value or an approximate value, which could be at least sufficiently used practically, of the elastic modulus Et′ of the PSA sheet. Unless specifically stated, Et′ and Es′ used herein may be interchangeably used. For example, Et′×(Ts)³ and Es′×(Ts)³ are interchangeably used.

The PSA sheet disclosed herein may have any elastic modulus Et′ without particular limitation, which may be, for example, 300 MPa or more or 500 MPa or more. From the viewpoint of easily obtaining the above preferable Et′×(Ts)³, the PSA sheet in some embodiments has an elastic modulus Et′ of, for example, preferably 1000 MPa or more or more preferably 1500 MPa or more (such as 2000 MPa or more). The upper limit of Et′ is not particularly restricted. From the viewpoint of availability of the substrate and ease of manufacture, it is generally appropriate that Et′ is 30,000 MPa or less, preferably 20,000 MPa or less and more preferably 10,000 MPa or less (such as 6000 MPa or less). Et′ may be adjusted by the configuration, materials and combinations thereof of the substrate.

The PSA sheet disclosed herein may have any thickness without particular limitation. The PSA sheet may have a thickness of, for example, 1 μm or more, and it is generally appropriate that the thickness is 3 μm or more (such as 5 μm or more) and may be 10 μm or more, 12 μm or more, 15 μm or more, 20 μm or more, 25 μm or more or 30 μm or more. In some embodiments, the PSA sheet may have a thickness of, for example, above 30 μm, 50 μm or more, 60 μm or more or 80 μm or more. The technique disclosed herein may be suitably exploited in an embodiment in which the PSA sheet has a thickness of, for example, 100 μm or more or 130 μm or more. The upper limit of the thickness of the PSA sheet is not particularly restricted. The technique disclosed herein may be exploited in an embodiment in which the PSA sheet has a thickness of, for example, 5 mm or less (such as 3 mm or less). In some embodiments, the PSA sheet may have a thickness of 1000 μm or less, 600 μm or less, 350 μm or less, 250 μm or less or 200 μm or less. In some other embodiments, the PSA sheet may have a thickness of 175 μm or less, 140 μm or less, 120 μm or less or 100 μm or less (such as less than 100 μm). Reducing the thickness may be advantageous in terms of handling and processing properties of the PSA sheet and reduction of thickness of a product formed with the PSA sheet.

The thickness of the PSA sheet refers to the thickness of a portion that is attached to an adherend (an article to be treated). For example, in the PSA sheet 1 having the configuration illustrated in FIG. 1, the thickness refers to the thickness from the PSA surface (attachment surface to the article to be treated) 21A of the PSA sheet 1 to the second surface 10B of the substrate 10 without including the thickness of the release liner 31.

<Release-Lined PSA Sheet>

The PSA sheet disclosed herein may have a form of a pressure-sensitive adhesive product containing a release liner attached to the surface of the PSA layer in order to protect the PSA surface. Thus, according to the present specification, a release-lined PSA sheet (PSA product), containing any of the PSA sheet disclosed herein and a release liner for protecting a PSA surface of the PSA sheet may be provided.

The release liner is not particularly limited and may be, for example, a release liner having a release layer on the surface of a liner substrate such as a resin film or paper (which may be paper laminated with a resin such as polyethylene), a release liner containing a resin film formed from a low-adhesive material such as a fluoropolymer (such as polytetrafluoroethylene) or a polyolefin resin (such as polyethylene and polypropylene). Because of excellent surface smoothness, a release liner having a release layer on the surface of a liner substrate which is a resin film or a release liner containing a resin film formed from a low-adhesive material may be preferably employed. The resin film is not particularly limited as far as the film can protect the PSA layer, and examples thereof include polyethylene films, polypropylene films, polybutene films, polybutadiene films, polymethylpentene films, polyvinyl chloride films, vinyl chloride copolymer films, polyester films (such as PET films and PBT films), polyurethane films, ethylene-vinyl acetate copolymer films and the like. In order to form the release layer, a well-known release agent such as a silicone release agent, a long-chain alkyl release agent, an olefin release agent, a fluorine release agent, a fatty acid amide release agent, molybdenum sulphide and silica powder may be used. It is particularly preferable to use the silicone release agent. The release layer may have any thickness without particular limitation and it is generally appropriate that the thickness is around 0.01 μm to 1μm and preferably around 0.1 μm to 1μm.

The release liner may have any thickness without particular limitation and it is generally appropriate that the thickness is around 5 μm to 200 μm (such as around 10 μm to 100 μm, preferably around 20 μm to 50 μm). It is preferable that the release liner has a thickness within the range because of excellent attachment workability to a PSA layer and peeling workability from the PSA layer. The release liner may be subjected to, as needed, antistatic treatment by application, kneading, vapour deposition and the like.

<Application>

The PSA sheet disclosed herein may suitably achieve both low initial adhesiveness and strong adhesiveness upon use. For example, adhesive strength is kept low for a while after attachment to an adherend in room temperature region (such as 20° C. to 30° C.), and preferable reworkability may be exhibited during this period. By utilising such low initial adhesiveness, the PSA sheet may be processed into or attached to certain shapes. The PSA sheet may have significantly increased adhesive strength by aging (which may be heating, a lapse of time or a combination thereof) and may obtain strong joining thereafter. For example, by heating at a desired timing, the PSA sheet may be strongly adhered to an adherend.

According to the present specification, a PSA sheet having excellent transparency of the PSA layer in addition to low initial adhesiveness and strong adhesiveness upon use is provided. Therefore, the PSA sheet disclosed herein is useful as a PSA sheet for optical applications. For example, the PSA sheet is useful as a PSA optical component comprising a support which is an optical component. When the optical component is an optical film, the PSA optical component serves as an optical film with a PSA layer. The optical film which may be used is a polarising plate, a retardation plate, an optical compensation film, a brightness enhancement film, a hard coat (HC) film, an antireflection film, an impact absorption film, an antifouling film, a photochromic film, a light control film, a wavelength selective absorbing film, a wavelength conversion film, laminates of the forgoing and the like.

Examples of a resin material that may be used for the optical film include polyester resins such as polyethylene terephthalate and polyethylene naphthalate, cellulose resins such as triacetyl cellulose, acetate resins, polysulphone resins, polyether sulphone resins, polycarbonate resins, polyamide resins, polyimide resins, polyolefin resins, cyclic polyolefin resins (such as norbornene resins), acrylic resins, polyvinyl chloride resins, polyvinylidene chloride resins, polystyrene resins, polyvinyl alcohol resins, polyarylate resins, polyphenylene sulphide resins and mixtures thereof. Among others, preferable materials include polyester resins, cellulose resins, polyimide resins and polyether sulphone resins.

The PSA sheet disclosed herein may be suitably used in an embodiment, for example, in which the PSA sheet is attached to a member included in various portable devices not only for above applications but also for applications of fixing, joining, forming, decorating, protecting, supporting or the like of the member. The term “portable” means to provide such portability that an individual (standard adult) can relatively and easily carry, and mere portability is not sufficient here. Examples of the portable devices as used herein include portable electronic devices such as portable phones, smart phones, tablet personal computers, laptop personal computers, various wearable devices, digital cameras, digital video cameras, acoustic devices (such as portable music players and IC recorders), computing devices (such as calculators), portable gaming devices, electronic dictionaries, electronic diaries, electronic books, in-vehicle information devices, portable radios, portable televisions, portable printers, portable scanners and portable modems, mechanical wristwatches and pocket watches, torches, hand mirrors and the like. Examples of the member included in the portable electronic devices may include optical films and display panels for image display devices such as liquid crystal displays and organic EL displays. The PSA sheet disclosed herein may be preferably used in an embodiment in which the PSA sheet is attached to a member in automobiles and home electric appliances for applications of fixing, joining, forming, decorating, protecting, supporting or the like of the member.

The subject matters disclosed herein encompass the following.

(1) A PSA sheet including a PSA layer, wherein:

an adhesive strength N1, after the PSA layer is attached to a stainless steel plate (SUS304BA plate) and left at 23° C. for 30 minutes, is 1.5 N/20 mm or less,

an adhesive strength N2, after the PSA layer is attached to a stainless steel plate (SUS304BA plate) and heated at 80° C. for 5 minutes, is 10.0 N/20 mm or more, and

the PSA layer has a haze value of 1.0% or less.

(2) The PSA sheet according to (1), wherein the PSA layer has a thickness of 5 μm or more but 35 μm or less.

(3) The PSA sheet according to (1) or (2), wherein the PSA layer contains a monomer unit derived from a (meth)acrylic monomer at a proportion of above 50% by weight in total monomer units in the PSA layer.

(4) The PSA sheet according to any of (1) to (3), wherein the PSA layer contains a monomer unit derived from a monomer having a polyorganosiloxane skeleton at a proportion of 0.05% by weight or more but 5% by weight or less in total monomer units in the PSA layer.

(5) The PSA sheet according to any of (1) to (4), wherein the PSA layer contains an acrylic polymer Pa having a glass transition temperature of 0° C. or lower and a siloxane structure-containing polymer Ps.

(6) The PSA sheet according to (5), wherein a content of the siloxane structure-containing polymer Ps is 0.1 parts by weight or more but less than 10 parts by weight relative to 100 parts by weight of the acrylic polymer Pa.

(7) The PSA sheet according to (5) or (6), wherein the siloxane structure-containing polymer Ps has a weight average molecular weight of 1×10⁴ or more but less than 5×10⁴.

(8) The PSA sheet according to any of (5) to (7), wherein the siloxane structure-containing polymer Ps is a copolymer of a monomer having a polyorganosiloxane skeleton and a (meth)acrylic monomer.

(9) The PSA sheet according to any of (1) to (8), wherein the PSA sheet includes a support substrate and the PSA layer is laminated on at least one surface of the support substrate.

(10) The PSA sheet according to (9), wherein the support substrate is a transparent resin film.

(11) The PSA sheet according to (9) or (10), wherein the support substrate has a thickness of 30 μm or more.

(12) The PSA sheet according to any of (9) to (11), wherein a relationship between an elastic modulus Et′ [MPa] of the PSA sheet and a thickness Ts [mm] of the support substrate fulfils the following formula: 0.1[N·mm]<Et′×(Ts)³.

(13) The PSA sheet according to any of (1) to (12), having an elastic modulus Et′ of 1000 MPa or more.

(14) The PSA sheet according to any of (1) to (13), wherein the adhesive strength N2 is 20 times or more of the adhesive strength N1.

(15) The PSA sheet according to any of (5) to (8), wherein the acrylic polymer Pa contains 50% by weight or more of monomer units derived from (meth)acrylic acid alkyl esters.

(16) The PSA sheet according to (15), wherein above 50% by weight of the (meth)acrylic acid alkyl esters is acrylic acid C₆₋₁₀ alkyl esters.

(17) The PSA sheet according to (15) or (16), wherein the acrylic polymer Pa contains, as a monomer unit, at least one monomer selected from the group consisting of a hydroxy group-containing monomer and an N-vinyl cyclic amide.

(18) The PSA sheet according to (17), wherein a total amount of the hydroxy group-containing monomer and the N-vinyl cyclic amide in the total amount of monomer components for preparation of the acrylic polymer Pa is 15% by weight or more but 50% by weight or less.

(19) The PSA sheet according to any of (15) to (18), wherein the acrylic polymer Pa and the siloxane structure-containing polymer Ps contain at least one monomer selected from the group consisting of MMA, BMA, 2EHMA, MA, BA and 2EHA as a common monomer unit.

(20) The PSA sheet according to (19), wherein the common monomer unit accounts for 5% by weight or more of total monomer units in the siloxane structure-containing polymer Ps.

(21) The PSA sheet according to (19) or (20), wherein the common monomer unit accounts for 5% by weight or more of total monomer units in the acrylic polymer Pa.

(22) The PSA sheet according to any of (1) to (21), wherein the PSA layer is formed with a pressure-sensitive adhesive composition including an isocyanate crosslinking agent.

(23) The PSA sheet according to (22), wherein the PSA layer contains, as a monomer unit, a hydroxy group-containing monomer, and a ratio (W_{OH}/W_{NCO}) of an amount W_{OH} of the hydroxy group-containing monomer used to an amount W_{NCO} of the isocyanate crosslinking agent used is 2 or more.

(24) A release-lined PSA sheet including:

the PSA sheet according to any of (1) to (23); and

the release liner for protecting a pressure-sensitive adhesive surface of the PSA sheet.

(25) The release-lined PSA sheet according to (24), wherein the release liner includes a release surface treated with at least one release agent selected from the group consisting of a silicone release agent, a long-chain alkyl release agent, an olefin release agent and a fluorine release agent.

### EXAMPLES

Some Examples relating to the present invention are hereinafter described. It should be noted that it is not intended to limit the present invention to the specific examples. In the description hereinbelow, “part(s)” and “%” are based on weight unless otherwise stated.

### Experimental Example 1

### (Preparation of Acrylic Polymer A1)

To a 4-neck flask equipped with a stirring blade, a thermometer, a nitrogen gas inlet tube and a condenser, 60 parts of 2-ethylhexyl acrylate (2EHA), 10 parts of methyl methacrylate (MMA), 15 parts of N-vinyl-2-pyrrolidone (NVP), 15 parts of 2-hydroxyethyl acrylate (HEA) and, as a polymerisation solvent, 200 parts of ethyl acetate were charged and stirred at 60° C. in a nitrogen atmosphere for 2 hours. Thereafter, as a thermal polymerisation initiator, 0.2 parts of 2,2′-azobisisobutyronitrile (AIBN) was added and the reaction was carried out at 60° C. for 6 hours to obtain a solution of acrylic polymer A1. The acrylic polymer A1 had Mw of 110×10⁴.

(Preparation of Acrylic Polymer A2)

To a 4-neck flask equipped with a stirring blade, a thermometer, a nitrogen gas inlet tube and a condenser, 95 parts of n-butyl acrylate, 5 parts of acrylic acid (AA) and, as a polymerisation solvent, 200 parts of toluene were charged and stirred at 60° C. in a nitrogen atmosphere for 2 hours. Thereafter, as a thermal polymerisation initiator, 0.2 parts of AIBN was added and the reaction was carried out at 60° C. for 6 hours to obtain a solution of acrylic polymer A2. The acrylic polymer A2 had Mw of 40×10⁴.

(Preparation of Siloxane Structure-Containing Polymer Ps1)

To a 4-neck flask equipped with a stirring blade, a thermometer, a nitrogen gas inlet tube, a condenser and a dropping funnel, 100 parts of toluene, 40 parts of MMA, 20 parts of n-butyl methacrylate (BMA), 20 parts of 2-ethylhexyl methacrylate (2EHMA), 8.7 parts of polyorganosiloxane skeleton-containing methacrylate monomer having a functional group equivalent of 900 g/mol (product name: X-22-174ASX, produced by Shin-Etsu Chemical Co., Ltd.), 11.3 parts of polyorganosiloxane skeleton-containing methacrylate monomer having a functional group equivalent of 4600 g/mol (product name: KF-2012, produced by Shin-Etsu Chemical Co., Ltd.) and, as a chain transfer agent, 0.51 parts of methyl thioglycolate were charged. The mixture was stirred at 70° C. under a nitrogen atmosphere for 1 hour. Thereafter, as a thermal polymerisation initiator, 0.2 parts of AIBN was added, the reaction was carried out at 70° C. for 2 hours, 0.1 parts of AIBN was added as a thermal polymerisation initiator, and then the reaction was carried out at 80° C. for 5 hours. Accordingly, a solution of siloxane structure-containing polymer Ps1 was obtained. The siloxane structure-containing polymer Ps1 had a weight average molecular weight of 22,000 and a glass transition temperature Tₘₗ based on the composition of (meth)acrylic monomers of about 47° C.

(Preparation of Siloxane Structure-Containing Polymer Ps2)

The composition of monomer components used for preparation of polymer Ps1 was modified to 50 parts of MMA, 15 parts of BMA, 15 parts of 2EHMA, 8.7 parts of X-22-174ASX and 11.3 parts of KF-2012. As a chain transfer agent, 0.8 parts of thioglycerol was used and as a polymerisation solvent, ethyl acetate was used. In the same manner as preparation of polymer Ps1 except for the above points, a solution of siloxane structure-containing polymer Ps2 was obtained. The polymer Ps2 had Mw of 19,700 and Tₘₗ of about 60° C.

(Preparation of Siloxane Structure-Containing Polymer Ps3)

The composition of monomer components used for preparation of polymer Ps1 was modified to 60 parts of MMA, 10 parts of BMA, 10 parts of 2EHMA, 8.7 parts of X-22-174ASX and 11.3 parts of KF-2012. As a chain transfer agent, 0.8 parts of thioglycerol was used and as a polymerisation solvent, ethyl acetate was used. In the same manner as preparation of polymer Ps1 except for the above points, a solution of siloxane structure-containing polymer Ps3 was obtained. The polymer Ps3 had Mw of 19,600 and Tₘₗ of about 74° C.

The weight average molecular weight of the above polymers was measured on a GPC device (produced by Tosoh Corporation, HLC-8220GPC) under the conditions indicated below and determined as based on polystyrene.

Sample concentration: 0.2 wt % (tetrahydrofuran (THF) solution)

Sample injection: 10 μ

Elution: THF, flow rate: 0.6 ml/min

Measurement temperature: 40° C.

Columns:
Sample columns; 1 TSKguardcolumn SuperHZ-H+2 TSKgel SuperHZM-H columns
Reference column; 1 TSKgel SuperH-RC column

Detector: differential refractometer (RI)

<Preparation of PSA Sheets>

### Example 1

To the solution of acrylic polymer Al, 2 parts of siloxane structure-containing polymer Ps1 and 0.25 parts of TAKENATE D-110N (an isocyanate crosslinking agent produced by Mitsui Chemicals, Inc.) as a crosslinking agent were added per 100 parts of acrylic polymer A1 in the solution and homogeneously mixed to prepare PSA composition C1.

PSA composition C1 was applied on a first surface of a support substrate, a polyethylene terephthalate (PET) film (produced by Toray Industries, Inc., product name “LUMIRROR”) of a thickness of 75 μm and heated at 110° C. for 2 minutes to form a PSA layer of a thickness of 15 μm, thereby obtaining a one-sided PSA sheet with a substrate in the form in which the PSA layer was laminated on one side of the support substrate. On a PSA surface of the PSA sheet, a release liner was attached to configure a release-lined PSA sheet. The release liner used was “DIAFOIL MRF” produced by Mitsubishi Plastics, Inc. (a release liner of a thickness of 38 μm having a release surface by means of a silicone release agent on one side of a polyester film). The PSA sheet according to Example 1 has Es′×(Ts)³ of 0.99 N·mm, and this value may be, as described above, regarded as Et′×(Ts)³.

### Example 2

PSA composition C2 was prepared in the same manner as PSA composition C1 except that the amount of the siloxane structure-containing polymer Ps1 used relative to 100 parts of the acrylic polymer A1 was changed to 5 parts. A PSA sheet according to the present Example was obtained in the same manner as in Example 1 except that PSA composition C2 was used.

### Example 3

To a solution of acrylic polymer A2, 5 parts of siloxane structure-containing polymer Ps 1 and 0.075 parts of TETRAD C (an epoxy crosslinking agent produced by Mitsubishi Gas Chemical Company, Inc.) as a crosslinking agent were added per 100 parts of the acrylic polymer A2 in the solution and homogeneously mixed to prepare PSA composition C3. A PSA sheet according to the present Example was obtained in the same manner as in Example 1 except that PSA composition C3 was used.

### Example 4

PSA composition C4 was prepared in the same manner as PSA composition C1 except that the amount of the siloxane structure-containing polymer Ps1 used relative to 100 parts of the acrylic polymer A1 was changed to 20 parts. A PSA sheet according to the present Example was obtained in the same manner as in Example 1 except that PSA composition C4 was used.

### Example 5

PSA composition C5 was prepared in the same manner as PSA composition C1 except that the siloxane structure-containing polymer Ps1 was not used. A PSA sheet according to the present Example was obtained in the same manner as in Example 1 except that PSA composition C5 was used.

### Example 6

PSA composition C6 was prepared in the same manner as PSA composition C3 except that the amount of the siloxane structure-containing polymer Ps1 used relative to 100 parts of the acrylic polymer A2 was changed to 20 parts. A PSA sheet according to the present Example was obtained in the same manner as in Example 3 except that PSA composition C6 was used.

<Measurement of Haze Value>

Each of PSA compositions C1 to C6 used in Examples was applied on a release surface of the release liner and heated at 110° C. for 2 minutes to form a PSA layer of a thickness of 15 μm. The PSA layer was attached on one side of an alkali glass having a haze of 0.1% and then heated at 80° C. for 5 minutes to allow sufficient manifestation of adhesive strength onto the alkali glass. Thereafter, the release liner was peeled off and the haze value was measured on a haze meter (MR-100 produced by Murakami Color Research Laboratory Co., Ltd.). Upon measurement, the alkali glass on which the PSA layer was attached was arranged so that the PSA layer was on the side of the light source. As the alkali glass had a haze value of 0.1%, 0.1% was subtracted from the measured value to obtain a haze value of the PSA layer.

<Measurement of Adhesive Strength to SUS>

The PSA sheets according to Examples together with release liners were cut into a width of 20 mm to obtain test strips. A SUS plate (SUS304BA plate) cleansed with toluene was used as an adherend and initial adhesive strength N1 and post-heating adhesive strength N2 were measured according to the following procedures.

(Measurement of Initial Adhesive Strength)

In a standard environment of 23° C. and 50% RH, the release liner covering the PSA surface of each test strip was peeled and the exposed PSA surface was press-bonded to the adherend with a 2 kg roller moved back and forth once. The test strip press-bonded to the adherend as above was left in the standard environment for 30 minutes, and then peeled over 180° on a universal tensile and compression testing machine (machine name “tensile and compression testing machine, TCM-1kNB” produced by Minebea, Inc.) according to JIS Z0237 under conditions of a peeling angle of 180 degrees and tensile speed of 300 mm/minute, thereby measuring adhesive strength (resistive force against the tension). Measurement was carried out 3 times and the average thereof was regarded as initial adhesive strength and indicated in the column of “Initial (Ni)” in Table 1.

(Measurement of Post-Heating Adhesive Strength)

A test sample press-bonded to an adherend in the similar manner as in measurement of initial adhesive strength N1 was heated at 80° C. for 5 minutes, left in the standard environment for 30 minutes and then peeled over 180° in a similar manner to measure adhesive strength. Measurement was carried out 3 times and the average thereof was regarded as post-heating adhesive strength and indicated in the column of “Post-heating (N2)” in Table 1.

When a PSA sheet according to Example fulfilled both an initial adhesive strength of 1.5 N/20 mm or less and a post-heating adhesive strength of 10.0 N/20 mm or more, the PSA sheet was graded as “G” (both light initial peelability and strong post-heating adhesiveness were good) and when a PSA sheet did not fulfil either or both an initial adhesive strength of 1.5 N/20 mm or less and a post-heating adhesive strength of 10.0 N/20 mm or more, the PSA sheet was graded as “P” (at least either of light initial peelability and strong post-heating adhesiveness was poor). The results are shown in Table 1. “NE” in the table represents absence of evaluation.

<Cohesive Strength Test>

The PSA sheets according to Examples together with the release liners were cut into the size of a width of 10 mm and a length of 100 mm to prepare test strips. The release liner was peeled off from each test strip to expose the PSA surface, and the test strip was, in an environment of 23° C. and 50% RH, press-bonded to a bakelite plate (phenol resin plate) as an adherend with pressure at an attachment area of a width of 10 mm and a length of 20 mm with a 2 kg roller moved back and forth once. The adherend including the test strip thus attached was drooped in an environment of 40° C. for 30 minutes so that the length direction of the test strip aligned with the vertical direction. Then, a load of 500 g was applied at the free end of the test strip and left in an environment of 40° C. for 1 hour while applying the load according to JIS Z0237. The test strip after the period was measured for a distance (displacement distance) displaced from the initial attachment position. Three test strips were used per PSA sheet for the measurement (namely n=3) and the arithmetic average of the displacement distances of the test strips was indicated in the column of “Cohesive strength” in Table 1.

TABLE 1

| | | Ex. 1 | Ex. 2 | Ex. 3 | Ex. 4 | Ex. 5 | Ex. 6 |
|---|---|---|---|---|---|---|---|
| Acrylic polymer | A1 | 100 | 100 | — | 100 | 100 | — |
| [parts] | A2 | — | — | 100 | — | — | 100 |
| Polymer Ps [parts] | | 2 | 5 | 5 | 20 | 0 | 20 |
| Crosslinking agent | Isocyanate-based | 0.25 | 0.25 | — | 0.25 | 0.25 | — |
| [parts] | Epoxy-based | — | — | 0.075 | — | — | 0.075 |
| Haze [%] | | 0.7 | 0.8 | 0.6 | 2.7 | 0.5 | 1.2 |
| Adhesive strength | Initial (N1) | 0.5 | 0.4 | 1.0 | NE | 14.0 | NE |
| [N/20 mm] | Post-heating (N2) | 22.0 | 19.0 | 17.3 | NE | 15.0 | NE |
| | Rise ratio (N2/N1) | 44.0 | 47.5 | 17.3 | — | 1.1 | — |
| | Evaluation | G | G | G | — | P | — |

| | | | | | | |
|---|---|---|---|---|---|---|
| Cohesive strength (500 g, 40° C., 1 hour) | 0.1 | 0.1 | 0.2 | 0.2 | 0.1 | 0.2 |
| [mm] | | | | | | |

As shown in Table 1, the PSA sheets according to Examples 1 to 3 had both low initial adhesive strength and strong post-heating adhesive strength, and also had low haze value. The PSA sheets of Examples 1 and 2 particularly had good results. On the other hand, the PSA sheets of Examples 4 and 6 had high haze value and the PSA sheet of Example 5 had high initial adhesive strength and lacked reworkability.

### Experimental Example 2

One-sided PSA sheets with substrates according to Examples 7 to 10 were obtained in the same manner as in Example 1 except that the siloxane structure-containing polymer and amount thereof and the amount of the crosslinking agent were as indicates in Table 2. The PSA sheets were measured for adhesive strength in the same manner as in Experimental Example 1. The results are shown in Table 2.

TABLE 2

| | | Ex. 7 | Ex. 8 | Ex. 9 | Ex. 10 |
|---|---|---|---|---|---|
| Acrylic polymer | A1 | 100 | 100 | 100 | 100 |
| [parts] | | | | | |
| Polymer Ps | Ps1 | 5 | 2 | — | — |
| [parts] | Ps2 | — | — | 2 | — |
| | Ps3 | — | — | — | 2 |
| Crosslinking agent | Isocyanate-based | 1.0 | 1.0 | 1.0 | 1.0 |
| [parts] | | | | | |
| Haze [%] | | 1.0 | 0.8 | 0.7 | 0.8 |
| Adhesive strength | Initial (N1) | 0.3 | 0.6 | 0.5 | 0.5 |
| [N/20 mm] | Post-heating (N2) | 13.8 | 21.0 | 20.0 | 19.0 |
| | Rise ratio (N2/N1) | 46.0 | 35.0 | 40.0 | 38.0 |
| | Evaluation | G | G | G | G |

As shown in Table 2, it was found that the PSA sheets according to Examples 7 to 10 also had low initial adhesive strength and strong post-heating adhesive strength, and had low haze value.

Specific examples of the present invention have been described in detail, which are merely examples and do not limit the scope of the claims. The technique recited in the claims encompasses various modifications and alterations of the specific examples exemplified hereinabove.

### REFERENCE SIGNS LIST

1, 2, 3 PSA sheets
Support substrate
10A First surface
10B Second surface
21 PSA layer (first PSA layer)
21A PSA surface (first PSA surface)
21B PSA surface (second PSA surface)
22 PSA layer (second PSA layer)
22A PSA surface (second PSA surface)
31, 32 Release liners
100, 200, 300 Release-lined PSA sheets (PSA products)

1. A pressure-sensitive adhesive sheet including a pressure-sensitive adhesive layer, wherein
a pressure-sensitive adhesive strength N1, after the pressure-sensitive adhesive layer is attached to a stainless steel plate (SUS304BA plate) and left at 23° C. for 30 minutes, is 1.5 N/20 mm or less,
a pressure-sensitive adhesive strength N2, after the pressure-sensitive adhesive layer is attached to a stainless steel plate (SUS304BA plate) and heated at 80° C. for 5 minutes, is 10.0 N/20 mm or more, and
the pressure-sensitive adhesive layer has a haze value of 1.0% or less.

2. The pressure-sensitive adhesive sheet according to claim 1, wherein the pressure-sensitive adhesive layer has a thickness of 5 μm or more but 35 μm or less.

3. The pressure-sensitive adhesive sheet according to claim 1, wherein the pressure-sensitive adhesive layer contains a monomer unit derived from a (meth)acrylic monomer at a proportion of above 50% by weight in total monomer units in the pressure-sensitive adhesive layer.

4. The pressure-sensitive adhesive sheet according to claim 1, wherein the pressure-sensitive adhesive layer contains a monomer unit derived from a monomer having a polyorganosiloxane skeleton at a proportion of 0.05% by weight or more but 5% by weight or less in total monomer units in the pressure-sensitive adhesive layer.

5. The pressure-sensitive adhesive sheet according to claim 1, wherein the pressure-sensitive adhesive layer contains an acrylic polymer Pa having a glass transition temperature of 0° C. or lower and a siloxane structure-containing polymer Ps.

6. The pressure-sensitive adhesive sheet according to claim 5, wherein a content of the siloxane structure-containing polymer Ps is 0.1 parts by weight or more but less than 10 parts by weight relative to 100 parts by weight of the acrylic polymer Pa.

7. The pressure-sensitive adhesive sheet according to claim 5, wherein the siloxane structure-containing polymer Ps has a weight average molecular weight of 1×10⁴ or more but less than 5×10⁴.

8. The pressure-sensitive adhesive sheet according to claim 1, comprising a support substrate and the pressure-sensitive adhesive layer is laminated on at least one surface of the support substrate.

9. The pressure-sensitive adhesive sheet according to claim 8, wherein the support substrate is a transparent resin film.

10. The pressure-sensitive adhesive sheet according to claim 1, wherein the pressure-sensitive adhesive strength N2 is 20 times or more of the pressure-sensitive adhesive strength N1.
